(19) United States
(12) Patent Application Publication
(10) Pub. No.: US 2013/0124319 A1
(43) Pub. Date: May 16, 2013

(54) PAYMENT OPTIONS BASED ON LOCATION

(71) Applicants: Andrew Hodge, Palo Alto, CA (US); Michael Rosenblatt, Campbell, CA (US); Amir M. Mikhak, Cambridge, MA (US); Gloria Lin, San Ramon, CA (US); Taido L. Nakajima, Cupertino, CA (US)

(72) Inventors: Andrew Hodge, Palo Alto, CA (US); Michael Rosenblatt, Campbell, CA (US); Amir M. Mikhak, Cambridge, MA (US); Gloria Lin, San Ramon, CA (US); Taido L. Nakajima, Cupertino, CA (US)

(73) Assignee: APPLE INC., Cupertino, CA (US)

(21) Appl. No.: 13/620,034

(22) Filed: Sep. 14, 2012

Related U.S. Application Data
(63) Continuation of application No. 12/286,341, filed on Sep. 30, 2008.

(51) Int. Cl. G06Q 30/06

(52) U.S. Cl. CPC G06Q 30/0623
USPC 705/14.54; 705/26.61

(57) ABSTRACT

Systems and methods are provided that allow for a portable electronic device to provide smart menus to a user based on a context of a transaction. Specifically, the method of using a portable electronic device may include opening a near field communication (NFC) channel with a point-of-purchase device and providing a smart menu based on a determined context. The portable electronic device may be configured to determine the context based at least in part upon acquiring sales transaction information for the point-of-purchase device. Additionally, the portable electronic device may be configured to determine the context based at least in part upon acquiring vendor identification information.

### CROSS-REFERENCE TO RELATED APPLICATIONS

Under 35 USC §120, this application is a continuation application and claims the benefit of priority to commonly-owned U.S. patent application Ser. No. 12/286,341, filed Sep. 30, 2008, entitled “Smart Menu Options”, all the contents of which are incorporated herein by reference.

### BACKGROUND

1. Technical Field

The present disclosure relates generally to portable electronic devices and, more particularly, to systems and methods for conducting wireless transactions with a portable electronic devices.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

It is not uncommon in the modern marketplace for consumers to have a variety of options for completing a purchase transaction. For example, consumers may have a variety of credit cards, debit cards, pre-paid cards, gift cards, etc., at their disposal, any one of which may be used to complete a transaction. In some instances, however, a particular retailer may not provide services for a particular type of credit card or debit card. In other cases, it may be advantageous to a consumer to use a particular card to make certain purchases based on a favorable interest rate, a rewards program, or other reasons. Additionally, retailers may have loyal customer cards, coupon cards, discount cards, etc. that allow them to target particular customers and offer discounted rates to consumers who present such cards. Despite the incentives to use one payment method over another for a particular transaction, generally, consumers may use the payment option that is the most convenient at the time (i.e., the card that is on top in their wallet) without considering that an alternative payment option may provide more benefits.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for executing purchase transactions, and related transactions, using a portable electronic device. For example, in some embodiments, a portable electronic device may be configured to recognize a retailer and recommend a payment method that accords with a consumer's preferences for that retailer or that provides a particular benefit when used at that retailer. Alternatively, or in addition, the portable electronic device may recognize that particular goods or services are being purchased and may recommend payment methods that provide a benefit when purchasing those goods or services. In some embodiments, the portable electronic device may be used to initiate a purchase transaction with the retailer and complete the purchase transaction by selecting a preferred payment option. In other embodiments, the portable electronic device may recommend payment methods and wait for feedback from a user before completing the transaction.

The recommended payment options may be set by the consumer. Specifically, the consumer may set preferences related to payment methods stored in the portable electronic device. The preferences may relate to interest rate, current balance, rewards, etc. to maximize benefits to the consumer. Alternatively, the portable electronic device may autonomously procure incentives related to a particular retailer, payment method, or goods and services and provide recommendations based on the information gathered.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects alone or in any combination. Again, the brief summary presented above is intended only to familiarize the reader with certain aspects and contexts of embodiments of the present disclosure without limitation to the claimed subject matter.

### BRIEF DESCRIPTION OF DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a front view of an electronic device in accordance with one embodiment;

FIG. 2 is a back view of an electronic device in accordance with one embodiment;

FIG. 3 is a simplified block diagram of the device in FIGS. 1 and 2 in accordance with one embodiment;

FIG. 4 is a block diagram illustrating a purchase transaction in accordance with one embodiment;

FIGS. 5-8 illustrate various ways in which the electronic device of FIG. 1 may discern the identity of a retailer in accordance with embodiments;

FIGS. 9 and 10 are front views of the electronic device in FIG. 1, illustrating methods of conducting a purchase transaction in accordance with embodiments;

FIG. 11 illustrates the electronic device of FIG. 1 obtaining information from another electronic device in accordance with one embodiment;

FIG. 12 is a front view of the other electronic device in FIG. 11, illustrating a financing traction with the electronic device of FIG. 1 in accordance with one embodiment;

FIGS. 13 and 14 are front views of the device in FIG. 1, illustrating selection of financing options and the completion of a purchase transaction in accordance with one embodiment;

FIGS. 15 and 16 are front views of the device in FIG. 1, illustrating a method of payment for the purchase transaction in accordance with various embodiments;

FIG. 17 is a flow chart illustrating steps related to the purchase transaction of FIG. 4 in accordance with one embodiment; and

FIGS. 18-20 illustrates another purchase transaction in accordance with an embodiment;

FIGS. 19-28 are front views of the device of FIG. 1, illustrating the setting of shopping preferences in accordance with various embodiments;

FIG. 29 is a flow chart illustrating a transaction in accordance with various embodiments;

FIG. 30 illustrates various menu options associated with the transaction of FIG. 29 in accordance with various embodiments; and

FIG. 31 is a flow chart illustrating logic flow for determining a payment option priority for a transaction in accordance with embodiments.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In view of the foregoing, it may be advantageous for a portable electronic device to be configured to provide smart menu options. In particular, the portable electronic device may be configured to conduct purchase transactions and present menu options to a user, such as recommended payment options for the purchase transactions, for example. The portable electronic device to store data related to payment methods, store user preferences related to the payment methods, and conduct purchase transactions with retailers via secure wireless communications channels. The portable electronic device may also be configured to determine the retailer's identity, the good or services being purchased, and the current status user preferences of the payment methods. With this information, the portable electronic device may present payment options and allow a consumer to select a preferred payment method or, alternatively, may complete the transaction automatically.

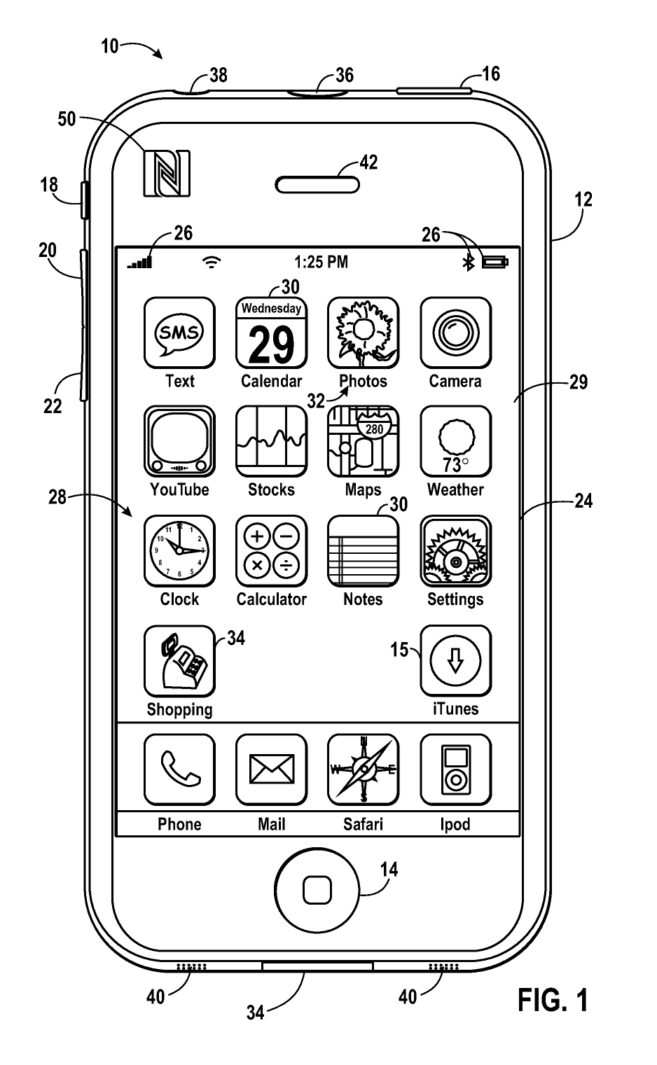

FIG. 1 illustrates an electronic device 10 that may include one or more shopping applications for providing the shopping related techniques briefly mentioned above. As illustrated in FIG. 1, the electronic device 10 may be a handheld device incorporating the functionality of one or more portable devices, such as a media player, a cellular phone, a personal data organizer, and so forth. Depending on the functionalities provided by the electronic device 10, the user may listen to music, play games, record video, take pictures, and place telephone calls, while moving freely with the device 10. In addition, the electronic device 10 may allow a user to connect to and communicate through the Internet or through other networks, such as local or wide area networks. For example, the electronic device 10 may allow a user to communicate using e-mail, text messaging, instant messaging, or other forms of electronic communication. The electronic device 10 also may communicate with other devices using short-range connections, such as Bluetooth and near field communication. By way of example, the electronic device 10 may be a model of an iPhone® available from Apple Inc. of Cupertino, Calif.

In the depicted embodiment, the device 10 is enclosed by a casing 12 that protects the interior components from physical damage and shields them from electromagnetic interference. The casing may be formed from any suitable material such as plastic, metal, or a composite. The casing allows access to user input structures 14, 16, 18, 20, and 22 through which a user may interface with the device. Each user input structure 14, 16, 18, 20, and 22 may be configured to control a device function when actuated. For example, the input structure 14 may include a button that when pressed causes a “home” screen or menu to be displayed on the device. The input structure 16 may include a button for toggling the device 10 between a sleep mode and a wake mode. The input structure 18 may include a two-position slider that silences a ringer for the cell phone application. The input structures 20 and 22 may include buttons for increasing and decreasing the volume output of the device 10. In general, the electronic device 10 may include any number of user input structures existing in various forms including buttons, switches, control pads, keys, knobs, scroll wheels, or other suitable forms.

The device 10 also includes a display 24 which may display various images generated by the device. For example, the display 24 may show photos, movies, album art, and/or data, such as text documents, spreadsheets, text messages, and email, among other things. The display 24 also may display system indicators 26 that provide feedback to a user, such as power status, signal strength, call status, external device connection, or the like. The display 24 may be any type of display such as a liquid crystal display (LCD), a light emitting diode (LED) display, an organic light emitting diode (OLED) display, or other suitable display. Additionally, the device 10 may include a touch screen disposed adjacent to the display 24, such that a user may select elements of the display 24 by touching them with the finger or a stylus.

The display 24 may be used to display a GUI 28 that allows a user to interact with the device. The GUI 28 may include various layers, windows, screens, templates, elements, or other components that may be displayed in all of or areas of the display 24. In certain embodiments, the user input structures 14, 16, 18, 20, and 22, may be used to navigate through the GUI 28. For example, the user input structures may include a wheel that allows a user to select graphical elements, shown here as icons 30, of the GUI 28. The icons 30 also may be selected via the touch screen.

The icons 30 may represent various layers, windows, screens, templates, elements, or other components that may be displayed in some or all of the areas of the display 24 upon selection by the user. Furthermore, selection of an icon 30 may lead to a hierarchical navigation process, such that selection of an icon 30 leads to a screen that includes one or more additional icons or other GUI elements. Textual indicators 32 may be displayed on or near the graphical elements 30 to facilitate user interpretation of each graphical element 30. It should be appreciated that the GUI 30 may include various components arranged in hierarchical and/or non-hierarchical structures.

When an icon 30 is selected, the device 10 may be configured to open an application associated with that icon and display a corresponding screen. For example, when the shopping icon 34 is selected, the device 10 may open a shopping program and display a shopping menu displaying the various tools and features available in the shopping program. For each application, screens may be displayed on the display 24 that include various user interface elements.

The electronic device 10 also may include various input/output ports 36, 38, and 40 that allow connection of the device 10 to external devices. For example, the I/O port 36 may be a connection port for transmitting and receiving data files, such as media files. Furthermore, the I/O port 36 may be a proprietary port from Apple Inc. The input/output port 38 may be a connection slot for receiving a subscriber identify module (SIM) card. The input/output port 40 may be a headphone jack that provides for connection of audio headphones. In other embodiments, the device 10 may include any number of input/output ports configured to connect to a variety of external devices, including but not limited to a power source, a printer, and a computer. In other embodiments, multiple ports may be included on a device. The ports may be any interface type such as a universal serial bus (USB) port, serial connection port, Firewire port, IEEE-1394 port, or AC/DC power connection port.

The electronic device 10 may also include various audio input and output elements. For example, input receivers 42 may include one or more microphones that receive user audio input such as a user's voice. Additionally, the electronic device 10 may include one or more output transmitters 44. The output transmitters 44 may include one or more speakers for transmitting audio signals to a user. The input receivers 42 and the output transmitters 44 may operate together as audio elements of a telephone.

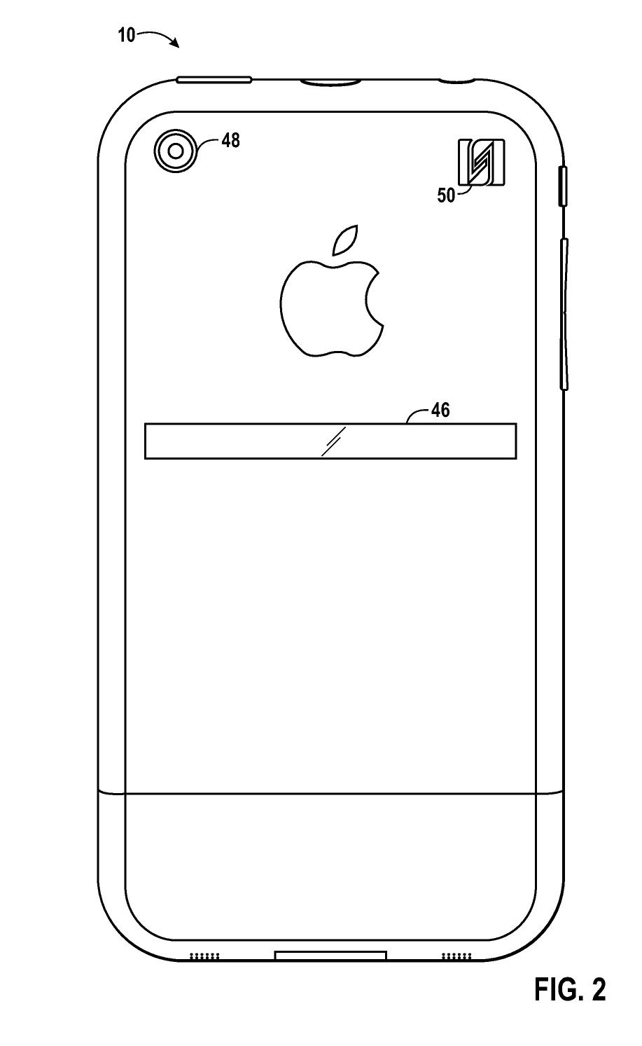

Turning now to FIG. 2, a back view of the device 10 is illustrated. As seen from the back view, the device 10 may include a scanner 46. The scanner 46 may be used to obtain product identifying information from a code, such as a bar code, a QR code, or the like. The product identifying information may then be used by the shopping program(s) of the device 10, embodiments of which will be described below. One of ordinary skill in the art will recognize various devices and techniques for implementing the bar code scanner 46 within the device 10.

The device 10 may also include a camera 48. The camera 48 may be used to shoot pictures and/or video. Moreover, as with the bar-code scanner, the camera 48 may also be used to identify certain consumer products. For example, the camera 48 may be used to capture an image of bar code, or other things, which may then be processed by the device 10 to extract the encoded product-identifying information. Techniques for processing a video image to extract coded information will also be known by those of ordinary skill in the art.

The device 10 may further include a near field communication (NFC) interface 50. The NFC interface 50 may be located within the casing 12 and a mark or symbol on the exterior of the casing 12 may identify its location within the casing 12. The NFC interface 50 may allow for close range communication at relatively low data rates (424 kb/s), and may comply with such standards as ISO 18092 or ISO 21481, or it may allow for close range communication at relatively high data rates (560 Mbps), and may comply with the TransferJet® protocol. The NFC interface 50 may have a range of approximately 2 to 4 cm, for example. The close range communication with the NFC interface 50 may take place via magnetic field induction, allowing the NFC interface 50 to communicate with other NFC devices such as radio frequency identification (RFID) tags, for example. In this way, the NFC interface 50 may be used to identify a consumer product that contains an NFC compatible device such as an RFID tag.

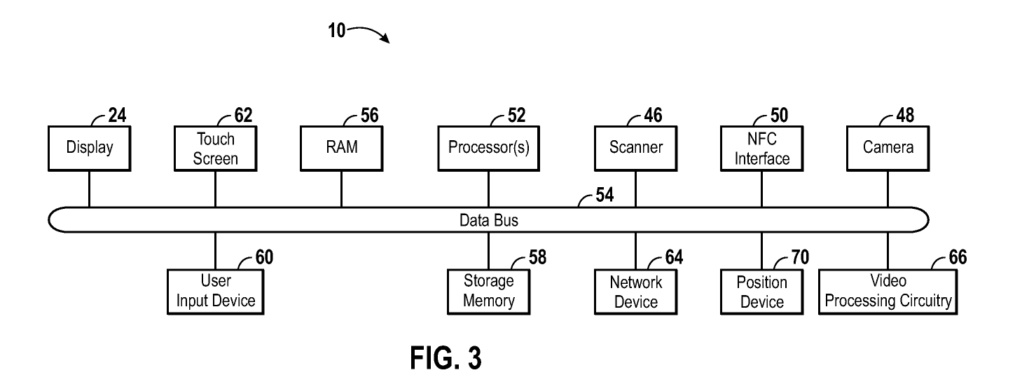

Turning now to FIG. 3, a block diagram of circuitry that may be used in the device 10 is provided. As stated above, the device 10 may include a scanner 46, a camera 48, and an NFC interface 50. The operation of the device 10 may be controlled by one or more processor(s) 52 that provide the processing capability required to execute the operating system, programs, graphical user interface 28, and any other functions of the device 10. The processor(s) 52 may include a single processor or a plurality of processors. For example, the processor(s) 52 may include “general purpose” microprocessors, a combination of general and special purpose microprocessors, instruction set processors, graphics processors, video processors, and/or related chips sets, and/or special purpose microprocessors. The processor(s) 52 also may include on board memory for caching purposes.

The processor(s) 52 may be coupled to a data bus 54 and configured to transmit PIO instructions to the various devices coupled to the data bus 54 or to initiate DMA transfers. As such, the data bus 54 may facilitate both DMA transfers and direct read and write instructions from the processor(s) 52. In embodiments, the data bus 54 may be an Advanced Microcontroller Bus Architecture (AMBA) compliant data bus.

The electronic device 10 may also include a random access memory (RAM) 56 electrically coupled to data bus 54. The RAM 56 may include any type of RAM, such as dynamic RAM and/or synchronous double data rate RAM, for example, and may also include non-volatile memory devices, such as ROM, EPROM and EEPROM or some combination of volatile and non-volatile memory. Additionally, the RAM 56 may also include a memory controller that controls the flow of data to and from the RAM 56.

Information used by the processor(s) 52 may be located within storage memory 58. The storage memory 58 of electronic device 10 may be used for storing data required for the operation of the processor(s) 52 as well as other data required by the device 10. For example, the storage memory 58 may store the firmware for the electronic device 10 usable by the processor(s) 52, such as an operating system, other programs that enable various functions of the electronic device 10, GUI functions, and/or processor functions. The storage memory 58 also may store components for the GUI 28, such as graphical elements 30, screens, and templates. Additionally, the storage memory 58 may store data files such as media (e.g., music and video files), image data, software, preference information (e.g., media playback preferences), wireless connection information (e.g., information that may enable the device 10 to establish a wireless connection, such as a telephone connection), subscription information (e.g., information that maintains a record of podcasts, television shows or other media to which a user subscribes), telephone information (e.g., telephone numbers), and any other suitable data. The storage memory 58 may be non-volatile memory such as read only memory, flash memory, a hard drive, or any other suitable optical, magnetic, or solid-state computer readable media, as well as a combination thereof.

A user may navigate through the GUI 28 (FIG. 1) using user input devices 60 coupled to input structures located at external surfaces of the device 10. The user input devices 60 may interface with the input structures 14, 16, 18, 20, and 22 shown in FIG. 1 and may communicate with the processor(s) 52 through an I/O controller (not shown.)

As noted above, a user may also control the device 10 by touching the graphical elements within the GUI 28. As such, a touch screen 62 may be positioned in front of or behind the display 24 and may be used to select graphical elements 30 shown on the display 24. The touch screen 62 is configured to receive input from a user's or object's touch and to send the information to the processor(s) 52, which interprets the touch event and performs a corresponding action. The touch screen 62 may employ any suitable type of touch screen technology such as resistive, capacitive, infrared, surface acoustic wave, electromagnetic, or near field imaging, and may be used in conjunction with or independently of the user input device 60 to select inputs for the device 10.

The device 10 may also include one or more network devices 64 for receiving and transmitting information over one or more broadband communications channels. As such, the network device 64 may include one or more network interface cards (NIC) or a network controller. In some embodiments, the network device 64 may include a local area network (LAN) interface for connecting to a wired Ethernet-based network and/or a wireless LAN, such as an IEEE 802.11x wireless network. In certain embodiments, the NFC interface 44 may be used to receive information, such as the service set identifier (SSID), channel, and encryption key, used to connect to the LAN.

The network device 64 also may include a wide area network (WAN) interface that permits connection to the Internet via a cellular communications network, such as an Enhanced Data rates for GMS Evolution (EDGE) network, or a Universal Mobile Telecommunications System (UMTS) network. Further, the network device 64 may include a personal area network (PAN) interface for connecting to a PAN such as a Bluetooth® network, an IEEE 802.15.4 (ZigBee) network, or an ultra wideband (UWB) network. The network device 64 may interact with an antenna to transmit and receive radio frequency signals of the network. The network device 64 may include any number and combination of network interfaces. Among other things, the network device 64 may allow the device 10 to send and receive a broad range of shopping related information, as will be described below.

The device 10 may also include video processing circuitry 66 coupled to the data bus 54. The video processing circuitry 66 may be configured to process video data, such as images received from camera 48, and send the processed video data to other parts of the system. For example, the video processing circuitry 66 may be configured to compress video data obtained from camera 48 into a JPEG or MPEG format and send the compressed video data to RAM 56 or storage memory 58. For another example, the video processing circuitry 66 may be configured to send uncompressed or decompressed video data to the RAM 56 or the display 24. For yet another example, the video processing circuitry may be used to extract textual or encoded information from an image, such as numbers, letters, and/or bar code information.

The device 10 may also include a positioning device 70 used to determine a user's geographical position. The positioning device 70 may utilize the global positioning system (GPS) or a regional or site-wide positioning system that uses cell tower positioning technology or Wi-Fi technology, for example. In some embodiments, the positioning device 70 may give exact coordinates of the device's location. Additionally, the positioning system 70 may be configured to provide the user's position relative to a map that may include topographical information, street names, and area details, including location and information related to retailers, for example.

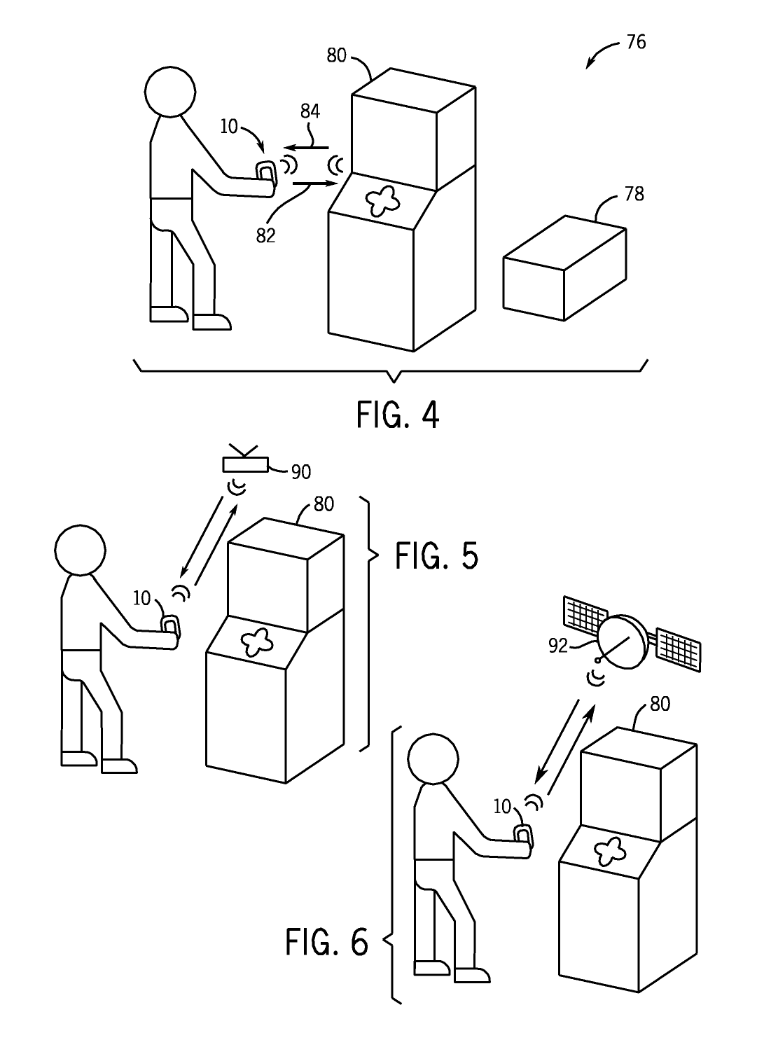

FIG. 4 illustrates a purchase transaction 76 in accordance with certain embodiments. The purchase transaction 76 may be initiated either before or after a product, such as product 78, or a service has been indicated as being the subject of the transaction. The product may be indicated as being the subject of the transaction by either scanning or otherwise entering product information about the product 78 into a point-of-purchase terminal 80 or scanning or otherwise entering information about the product into the device 10, for example. Commonly assigned patent applications by Gloria Lin, Amir, Mikhak, Taido, Nakajima, Sean Mayo and Michael Rosenblatt, entitled “Portable Point of Purchase Devices and Methods,” filed Sep. 30, 2008, application Ser. Nos. 12/286,445 and 12/286,421 are incorporated herein in their entirety, for all purposes, by reference and include descriptions of various techniques regarding identification of products by the device 10. Additionally, the commonly assigned patent application by Michael Rosenblatt, filed Sep. 30, 2008, entitled “Real Time Bargain Hunting,” patent application Ser. No. 12/286,362 is incorporated herein, for all purposes, in its entirety by reference.

Although the terminal 80 is illustrated as a kiosk, the terminal 80 may be a manned or unmanned terminal and may be configured to scan products to be purchased or to allow a user to indicate products or services for purchase. Additionally, the terminal 80 may be fixed in a particular location, or it may be portable. The terminal 80 may communicatively couple to one or more servers of a retailer's computer network and/or with servers of financial institutions to allow for the completion of sales transactions.

Additionally, in order to conserve the resources of the device 10, the device 10 may be configured to only conduct a purchase transaction and/or other steps associated with the purchase transaction when a user has first set the device 10 into a purchasing mode. For example, a user may place the device into a purchasing mode by selecting the shopping icon 34 (FIG. 1). Once in a purchasing mode, the device 10 may be configured to periodically scan for NFC enabled devices, among other things, which may consume battery power and processing bandwidth.

A communication channel may be opened between the device 10 and a point-of-purchase terminal 80 in any suitable manner. For example, the communication channel may be opened by placing the device 10 within communication range (2-4 inches) of terminal 80 to allow for NFC communications to initiate. Specifically, the device 10 may initially communicate with the kiosk via communication channel 82 to indicate that it is an NFC enabled device and that it is configured to conduct purchase transactions. In response, the terminal 80 may respond via communication channel 84 that the product 78 has been scanned and/or that another product or service has been indicated as being part of a sale.

As mentioned above, the device 10 may be configured to recommend or select payment options that provide the greatest benefit to a user or that are in accordance with a user's personal preferences. To accomplish this, the device may be configured to determine the identity of a retailer from which goods or services are being purchased. In some embodiments, the device 10 may determine the identity of the retailer based on the information transmitted from the terminal 80 via the NFC channel 84. Thus, the identity of the retailer may not be known to the device until the user is ready to make a purchase.

In alternative embodiments, the device 10 may be able to determine the identity of a particular retailer well in advance of the time of purchase. For example, the device 10 may be configured to determine the identity of the retailer using a Wi-Fi connection. For example, some retailers and service providers may provide free or subscription based wireless Internet access via access devices, such as access device 90 in FIG. 5, for example, which may be located throughout a commercial retail space. The device 10 may obtain retailer identification through the access devices. In some embodiments, access to the Internet may not be provided to customers, but the access devices, such as access device 90, may be configured to provide retailer identification information to the device 10.

In some embodiments, the device 10 may employ a device identification networking protocol to search for other electronic devices having wireless network access. By way of example, the device identification networking protocol may operate by having each device broadcast identification information and information regarding capabilities of the device. Bonjour® by Apple Inc. is one example of an identification networking protocol that operates in such a manner. In some embodiments, the terminal 80 and/or the device 10 may broadcast their identifications and services, programs, and/or communication capabilities that each device may have using internet protocol (IP). The device 10 may receive information via the device identification networking protocol so as to open peer-to-peer connections via a PAN communication channel or a LAN communication channel with an available terminal 80. As should be appreciated, more than one electronic device 10 may be broadcasting information using the device identification networking protocol. As such, the device 10 may select the terminal based on user preferences for certain characteristics, which may include owner identification, manufacturer identification, etc.

In yet other embodiments, the device 10 may obtain retailer identification information based on a specific location of the device 10, as determined by the positioning system 70. Specifically, the positioning system 70 may be configured to determine a retailer's identity based on positioning information from communications with a satellite 92, as shown in FIG. 6. In other embodiments, retailer identification information may be obtained by determining the location of the device 10 based on communications with a cellular tower 94 or cellular network technology, as shown in FIG. 7.

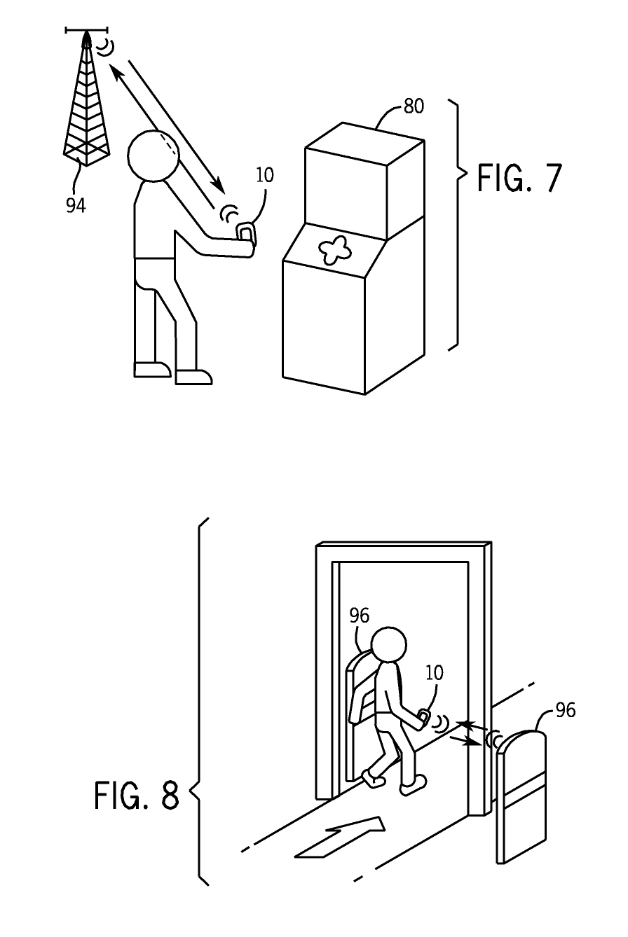

Additionally, in other embodiments, NFC transmitters 96 may be positioned near an entrance of businesses to indicate the identity of the retailers as shown in FIG. 8. Specifically, the device 10 may communicate with NFC transmitters 96 when a user enters a store to determine the identity of the retailer. The above described techniques for determining the identity of a retailer are given as examples and are not intended to limit the scope of the disclosure. As such there may be other ways not discussed herein for the device 10 to determine the retailer's identity that similarly may be within the scope of the present disclosure.

To facilitate the following discussion regarding the operation of the device 10 in conducting a purchase transaction with the terminal 80, reference is made to drawings which may be representative of possible screen shots of the device 10 during the transaction 78. The functionality described may be achieved with a wide variety graphical elements and visual schemes. Therefore, the present embodiments are not intended to be limited to the precise user interface conventions adopted herein. Rather, embodiments may include a wide variety of user interface styles. Indeed, the presently disclosed user interface conventions are based on Apple's iPhone for the convenience of the reader, although other user interface conventions could readily be used to carry out the present techniques.

In some embodiments, the device 10 may initially attempt to determine the location of the device for the purposes of conducting a purchase transaction after a user has selected the shopping button 34 from the home screen 29. Upon selection of the shopping button 34, the device may display a home shopping screen 100 which may include various options related to shopping. For example, the home shopping screen 100 may include a scan item button 102 to prompt the device 10 to scan an item, a shopping list button 104 that allows a user to set up a shopping list in accordance with embodiments described in the commonly assigned patent application filed Sep. 30, 2008, by Michael Rosenblatt, entitled “Real Time Bargain Hunting,” patent application Ser. No. 12/286,362, which is incorporated herein by reference. Additionally the home shopping screen may have a shopping preference button 106 to allow a user to set shopping preferences, as will be discussed in detail below, and a purchase button 108 to initiate a purchase.

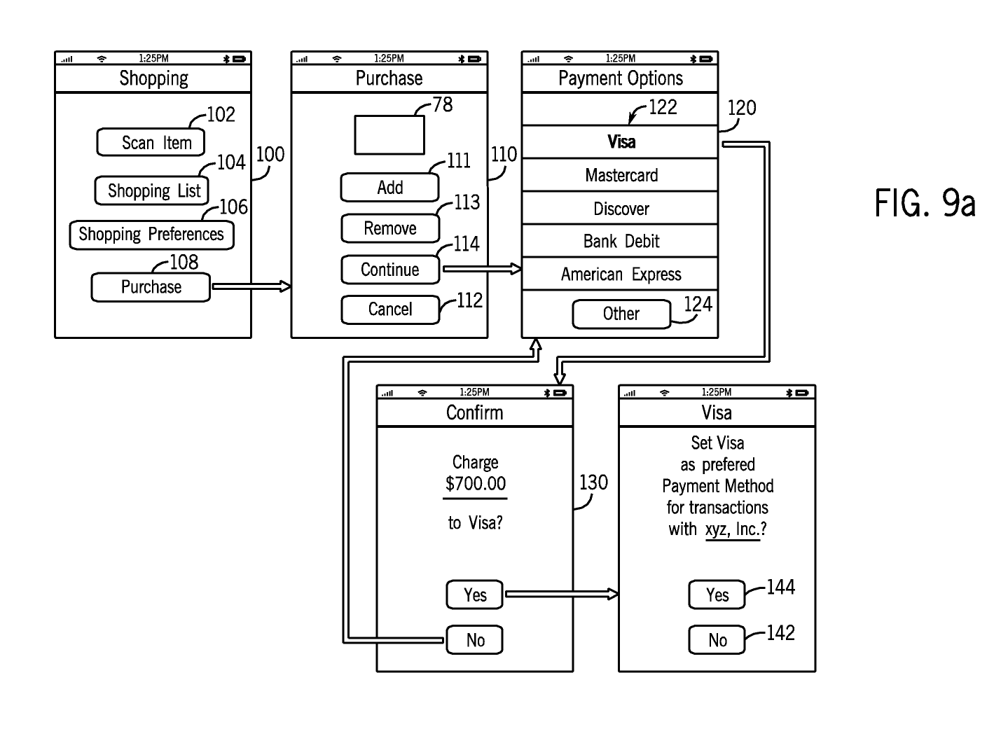

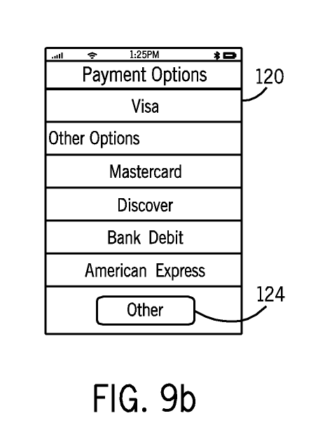

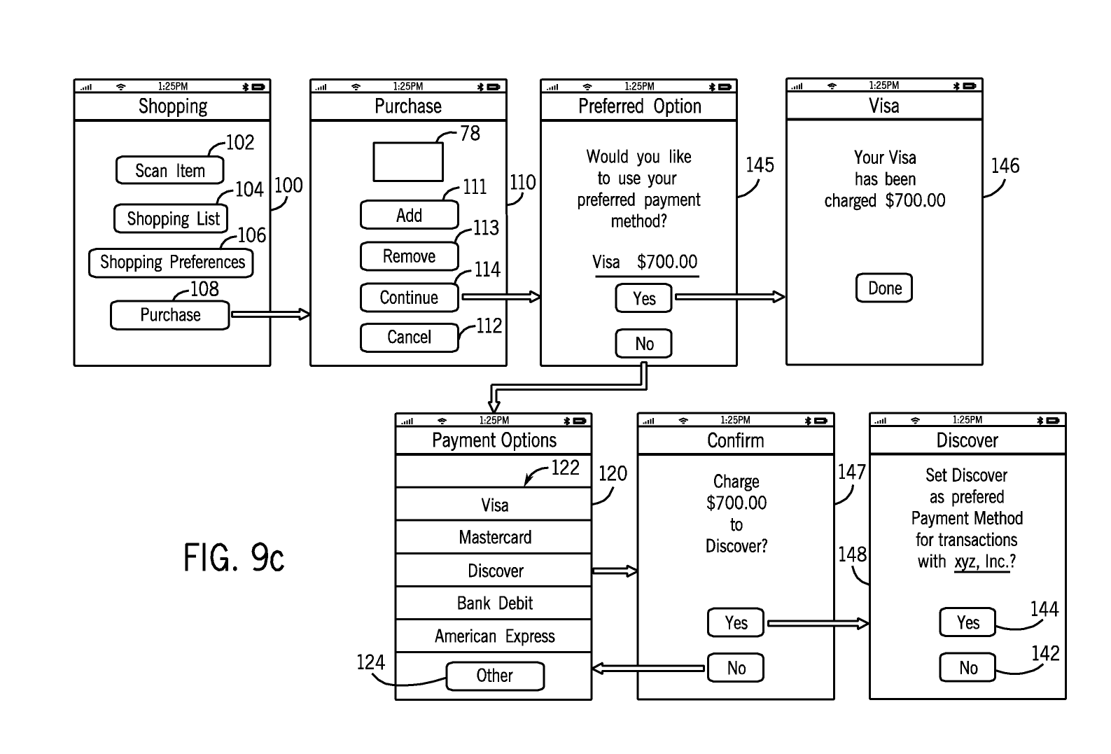

In some embodiments, a user may be brought directly to the purchase screen after the device 10 has determined the identity of the retailer, a purchase screen 110, as shown in FIG. 9a, may prompt the user to indicate whether the user desires to purchase the scanned items from the retailer. In other embodiments, a user is brought to the purchase screen 110 upon selection of the purchase button 108, a purchase screen 110 may be displayed.

The purchase screen 110 may list items, such as product 78, and prices for a user to review. The device 10 may be configured to wait for a user to indicate whether to continue with the transaction. The user may select to add or remove items using the add or remove buttons 111 and 113. In instances where multiple services or devices have been scanned or identified as being the subject of the transaction, a user may view all items that are to be the subject of the transaction by scrolling the screen up or down. Additionally, if the user selects the cancel button 112, the device 10 may return to a home screen 29. Alternatively, if the user indicates a desire to complete the transaction with the retailer by selecting the continue button 114, a user may be brought to a payment options screen 120.

The payment options screen 120 may include a prioritized listing 122 of possible payment options that have been stored on the device 10. For example, the listing 122 may include a Visa card, a Mastercard, a Discover card, a bank debit card, and an American Express card, among others. In some embodiments, the prioritized listing 122 may be created based on user specified preferences, as will be discussed in greater detail below. In some embodiments, one payment option may be identified as a preferred payment option or default payment option, as illustrated in FIG. 9b. The preferred payment option may be the first listed and may also be set apart from the other payment options. For example, the preferred payment option may be Visa, as shown, and may be larger font size than the other options. Although the preferred payment option is most prominently displayed, other options are also provided and may also be listed in order of preference according to the teachings disclosed herein.

In other embodiments, the listing 122 may be created based on interest rates, promotional incentives (such as cash rebates for using a particular card to purchase specific items, for example), existing balance, types of goods, retailer identity, etc. The device 10 may be configured to store such information related to the payment options based on user input or, alternatively, the device 10 may be configured to interact with various payment option accounts via the Internet to determine the information. Additional details will be presented below with regard to embodiments that may enable the device to collect such information.

Referring again to FIG. 9a, as illustrated, the priority listing 122 may suggest a Visa card as the best payment option when purchasing a product from a particular retailer. As mentioned above, the suggestion may be based on the context of the transaction including the identity of the retailer and other variables related to the payment options. For example, the Visa card may have a favorable interest rate or rebate available for purchases with the retailer.

In other embodiments, the device 10 may be configured to prioritize the listing 122 based on prior transactions. For example, it may be the case that a user has conducted ten prior transactions using the payment options stored on the device 10 and in seven of the ten transactions the user used the Mastercard, while in the three other transactions the Discover card was used. As such, the device 10 may prioritize the Mastercard as a first suggested payment option and the Discover card as the second suggested payment option.

In yet other embodiments, the listing 122 of suggested payment options may be based on a user's prior purchase transactions with a particular retailer or based on purchases of similar products. For example, if the user had previously purchased products from the retailer using the American Express card, the American Express card may be first suggested for subsequent transactions with that retailer. Additionally, if the user had previously purchased groceries using a particular card, the same card may be suggested for future purchases of groceries.

From the payment options screen 120, the user may select a listed payment option or may use an other button 124 to select payment options that are not listed. If the user selects the Visa card, as shown, the user may be directed to a confirmation screen 130. The confirmation screen may confirm the charges are to be made to the selected payment options. The user may indicate that the charges should not be made to the selected payment option by selection the no button 132. Alternatively, the user may confirm the selection of the payment option at which point the user may be required to provide a signature, PIN or other authentication action. Typically, the terminal 80 will provide an electronic pad to allow for the authentication action. In some embodiments, the device 10 may allow for the user to perform the authentication action on the device 10 itself and then transmit the authentication information to the terminal 80.

In some embodiments, the device 10 may be configured to forego the confirmation screen 130. Specifically, the device 10 may be configured to provide information related to the selected payment option to the terminal 80 immediately after the user has selected the payment option. The terminal 80 may then communicate with a server for the selected payment option to confirm the payment option for the transaction. As such, once the user has selected a payment option, the user may simply provide authentication information in order to complete the transaction.

Once the transaction is completed, the device 10 may prompt the user to set preferences that may be used for future purchases. Specifically, a user may be brought to a preference screen 140 that may ask whether the selected payment option should be used for all future transactions with the retailer. If the user selects the “yes” button 142, the card may be prioritized as the first suggested option for future transactions with the retailer. If a card priority is set in this manner, it may supersede other context based preferences or other general preferences. Specifically, if a particular card is indicated for transactions with particular retailer, that card will be prioritized over cards that have been generally labeled as a “favorite” or cards that may have historically been used for other transactions with other retailers. If, however, the user selects the “no” button 144, a prioritization list of payment options will be created in accordance with other context based settings, or the user's previous preferences.

In yet other embodiments, as illustrated in FIG. 9c, the device 10 may be configured to ask a user if a preferred payment method should be used after the user has selected the continue button 114 from the purchase screen 110. Specifically, a preferred option screen 145 may be shown from which a user may select to continue with an identified preferred payment option or to select another payment options. The preferred option screen 145 may indicate the preferred option, such as Visa, and the price associated with the purchase transaction, as illustrated. The preferred option may be selected by the device 10 based on any of the possible indicators set forth above including, for example, previous purchases, user set preferences, retailer identity, and interest rate, etc.

If the user selects to proceed using the preferred payment method by selecting the yes button from the preferred option screen 145, the transaction may be completed by the device 10 and a screen 146 may indicate completion of the transaction. Alternatively, a user may decline the preferred payment option by selecting the no button from the preferred options screen 145, in which case, the device 10 may display the payment options screen 120 and select from a prioritized listing 122, as discussed above. After the user selects a payment options a confirmation screen 147 may appear for a user to confirm that the selected payment option is to be used for the transaction. The user may select no to be returned to the payment options screen 120. Otherwise, the user may select yes to complete the transaction upon which the device may display a preferences screen 148 from which the user may be asked to indicate weather the selected payment method should be set as the preferred payment method for future transactions. Thus, the selected payment method may be set as the preferred payment option for transactions having a similar context (i.e., similar goods, same retailer, etc.) in the future.

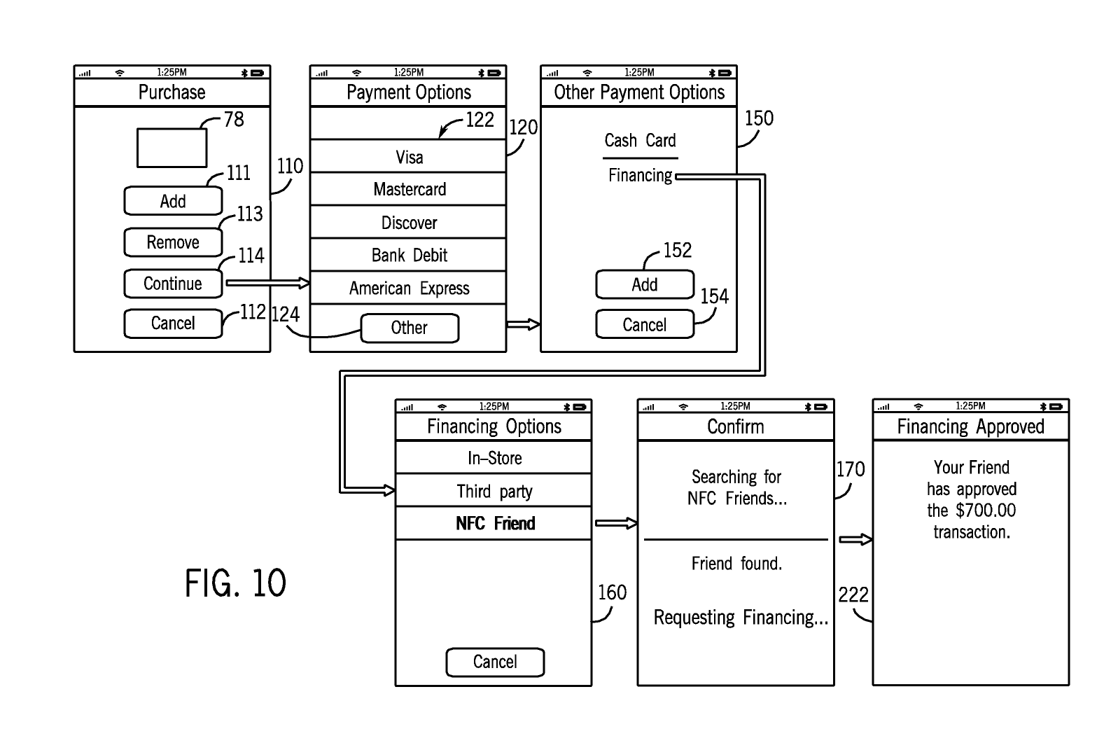

In some embodiments, the device 10 may be configured to complete the transaction using financing options. For example, as above, the user may select the purchase button 108 from the shopping home screen 100 to be brought to purchases screen 110. As illustrated in FIG. 10, the user may navigating from the payment options screen 120 using the “other” button 124 to select other payment options. The user is brought to the other payment option screen 150 which may list other payment options such as a cash card and financing, for example. From the screen 150, the user may select one of the listed options, add additional payment options by selecting the “add” button 152, or return to the previous payment options screen using the “cancel” button 154. Upon selection of the cash card option, the user may conduct the transaction as set forth above in FIG. 9. Additionally, the cash card option may be added to the payment option screen 120 for future transactions if a balance remains on the card following the transaction.

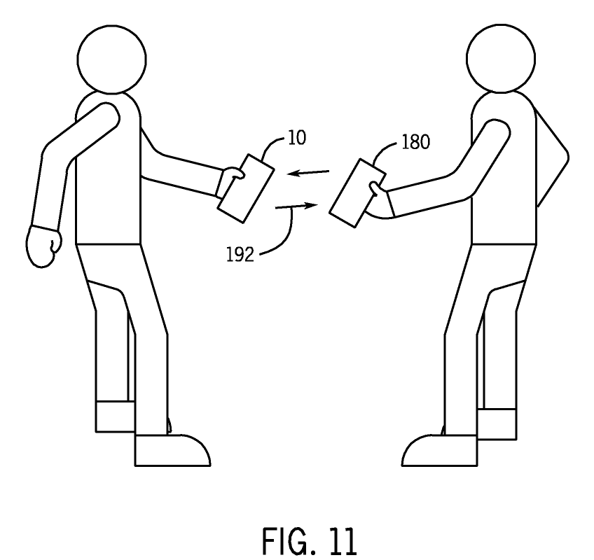

Alternatively, if the user selects financing, a financing options screen 160 may appear that may list possible financing options, such as in-store financing, third party financing, or friend financing, for example. Upon selection of friend financing, the device 10 may search for other devices, as illustrated by search screen 170. For example, the device 10 may be configured to search for another wirelessly enabled device, such as an NFC enabled device, a Wi-Fi device, or an Internet enabled device, etc., for a set period of time, such as ten seconds, for example, before returning to the financing options screen 160 or providing a screen (not shown) that indicates that no friend was found. The device 10 may then request if the user would like to try again or try other financing options. During the search period, a user may place the device 10 within NFC communication range of another NFC device 180, as illustrated in FIG. 11. If the device 10 is able to open a communication channel with the other NFC device 180, the device 10 may indicate that a friend was found and that financing is being requested, as shown.

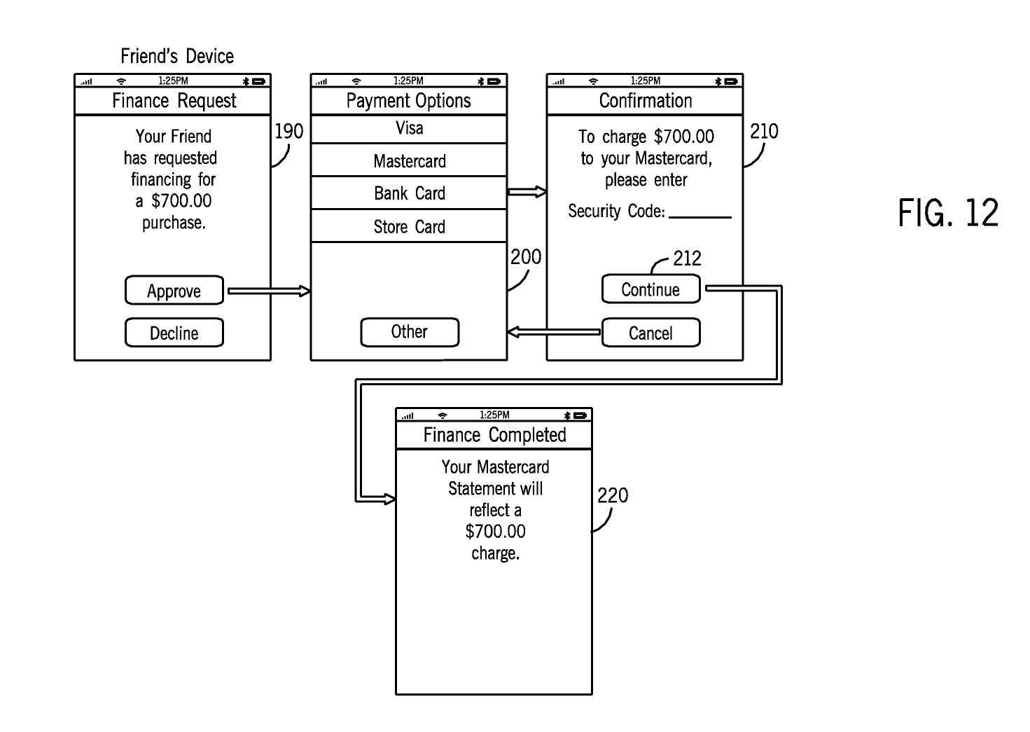

When friend financing is requested, the other NFC device 180 may be configured to display a finance request screen 190, as illustrated in FIG. 12. In some embodiments, the other device 180 may only direct a user to the finance request screen 190 after the user has selected a shopping button 34 or otherwise indicated that a request may be forthcoming and after receiving the financing request via wireless communications. The finance request screen 190 may state that financing has been requested and the amount of the financing being requested. In some embodiments, the financing request screen 190 may provide a link to an Internet site (not shown) to allow the user of the other device 180 to secure third party financing for the transaction.

In some embodiments the finance request screen 190 may identify the individual requesting the financing, for example, by stating the name of the requester as communicated from the device 10 via an NFC communication channel 192 or other suitable channel. The friend financing may then be approved using an approve button 194 or declined using the decline button 196. If the decline button 192 is selected, the NFC device 180 may return to a main menu or display content that was being displayed prior to the finance request.

Upon approval of the financing request, the NFC device 180 may provide a payment options screen 200, similar to the payment option screen 120 previously described. The user may then select a payment option from a listing 202 that may be prioritized by the NFC device 180 to reflect the contextual advantages and user preferences as described herein. Upon selection of a payment option, the NFC device 180 may display a confirmation screen 210 to allow a user to confirm the charges to the user's account. In some embodiments, an authentication may be required, such as a security code, user pin, signature, or password, for example. The user may cancel the use of the selected payment option and return to the payment options screen 200 or, alternatively, select the continue button 212 which will complete the financing transaction. If the financing transaction is completed, the NFC device 180 may display a finance completed screen 220 that indicates that charges will be seen in a forthcoming statement from the selected payment option. Additionally, the device 10 may display a financing approval screen 222 (FIG. 10) indicating that the NFC friend had agreed to finance the transaction. The device 10 may then be configured to receive the payment option information from the NFC device 180 and transfer the information to the terminal 80 to complete the transaction. Alternatively, the NFC device 180 may be configured to communicate directly with the terminal 80 to complete the transaction.

There may be several ways to transfer information from NFC device 180 to device 10 in a peer-to-peer type financial transactions. The commonly assigned patent application filed Sep. 30, 2008, by Gloria Lin, Amir Mikhak, Taido Nakajima, Sean Mayo and Michael Rosenblatt, entitled “Peer-to-Peer Financial Transactions,” patent application Ser. No. 12/286,494 describes a number of peer-to-peer transactions and, as such, is incorporated herein, for all purposes, in its entirety by reference.

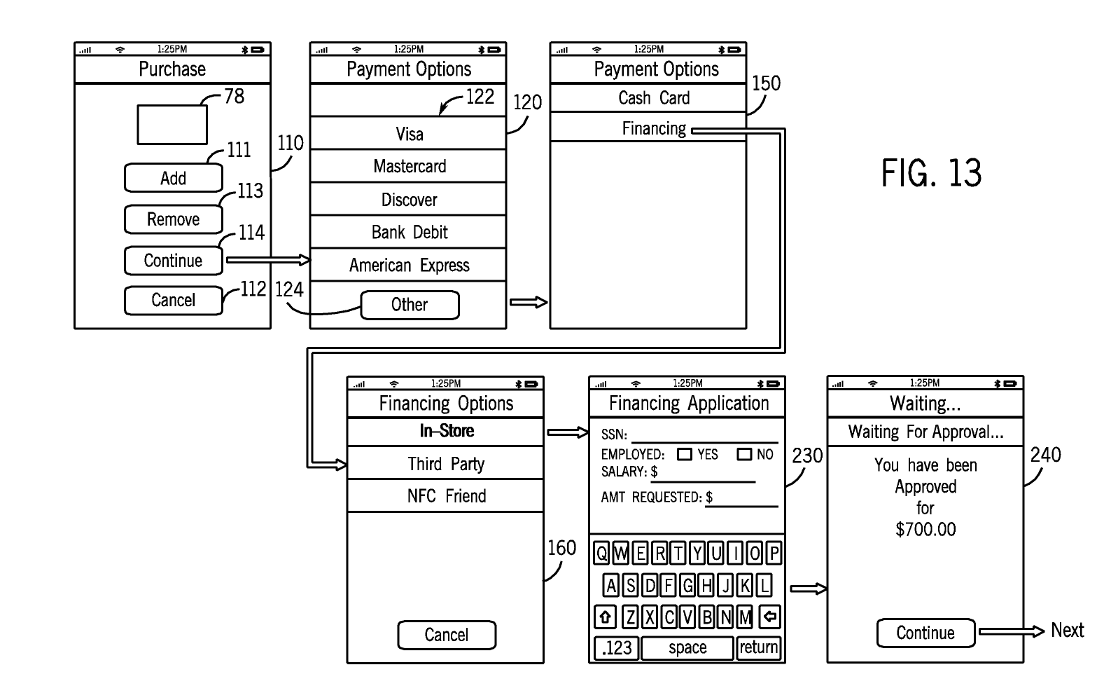

Referring to FIG. 13, if, after selecting financing from screen 150, the user selects either in-store financing or third party financing from the financing options screen 160, the device 10 may connect directly with servers for financial institutions that supply the financing via the network devices 64 (FIG. 3) and the device 10 may display a financing application screen 230. Alternatively, the device 10 may connect over the Internet with a website (not shown) for a financial institution and the user may navigate the website to apply for credit from the financial institution by filling in online forms provided by on the website.

The financing application screen 230 may include fields containing sensitive data such as social security numbers, salary information, contact information, etc. of the user applying for credit. As the financing institutions and the amount of financing may vary, the content of the form and the information required by the form may vary.

The user may fill in the various fields of the form using a keyboard 232 provided on the financing application screen 230. Upon completion of the form, the user may submit the financing application. The device 10 may then await approval and display a waiting screen 240. If the user is approved for financing, the waiting screen 240 may indicate the approval as well as an amount of credit for which the user has qualified. The user may then select continue 242 to complete the financing.

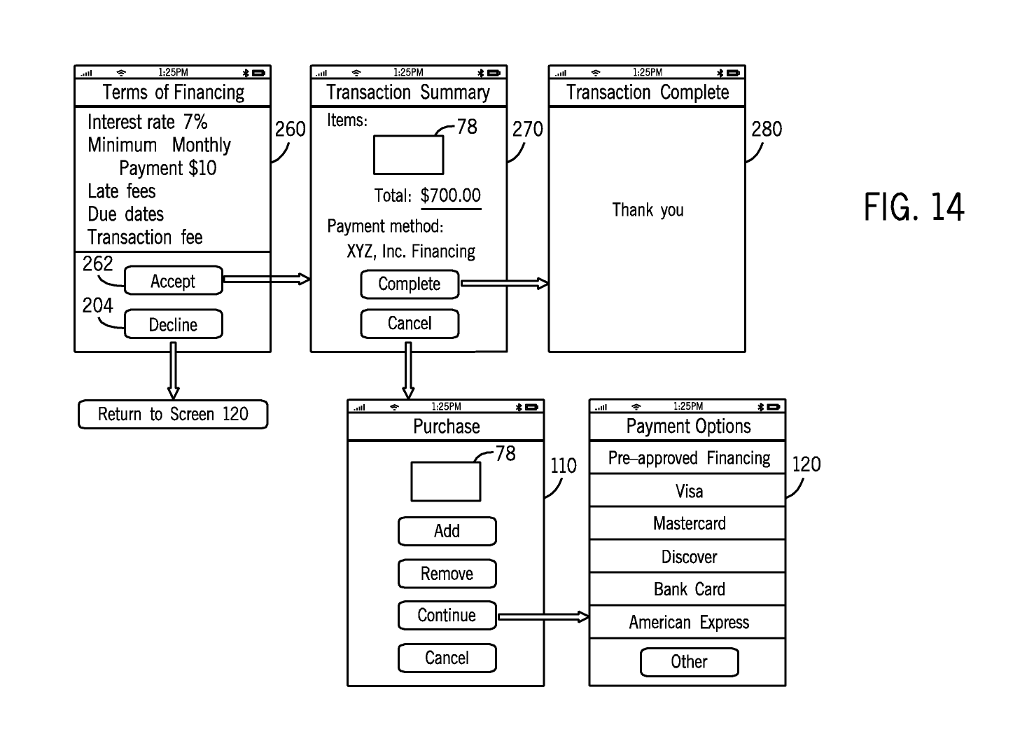

After being approved for financing, terms of financing screen 260 may be displayed. The terms of financing screen 260 may include the terms of the financing agreement, such as interest rate, payment schedule, and fees associated with the financing arrangement. The user may then either accept or decline the terms (and hence the financing) using buttons 262 and 264. If the user elects to decline, the user may be returned to the payment options screen 120 to select another form of payment. Alternatively, if the user elects to accept the terms, the device 10 may display a transaction summary screen 270 that may allow the user to complete the transaction or cancel the transaction by selecting either a complete button 272 or a cancel button 274. The transaction summary screen 270 may display the items to be purchased as well as the price being paid. If the user selects the complete the transaction, the user may be brought to transaction complete screen 280. Alternatively, if the user selects to cancel the transaction, the user may be returned to the purchase screen 110 to add or remove items or to continue and select different payment options. If the user adds or removes items and then continues or just simply continues, the previously approved financing may be listed as the first suggested payment option in the payment options screen 120, as shown in FIG. 14.

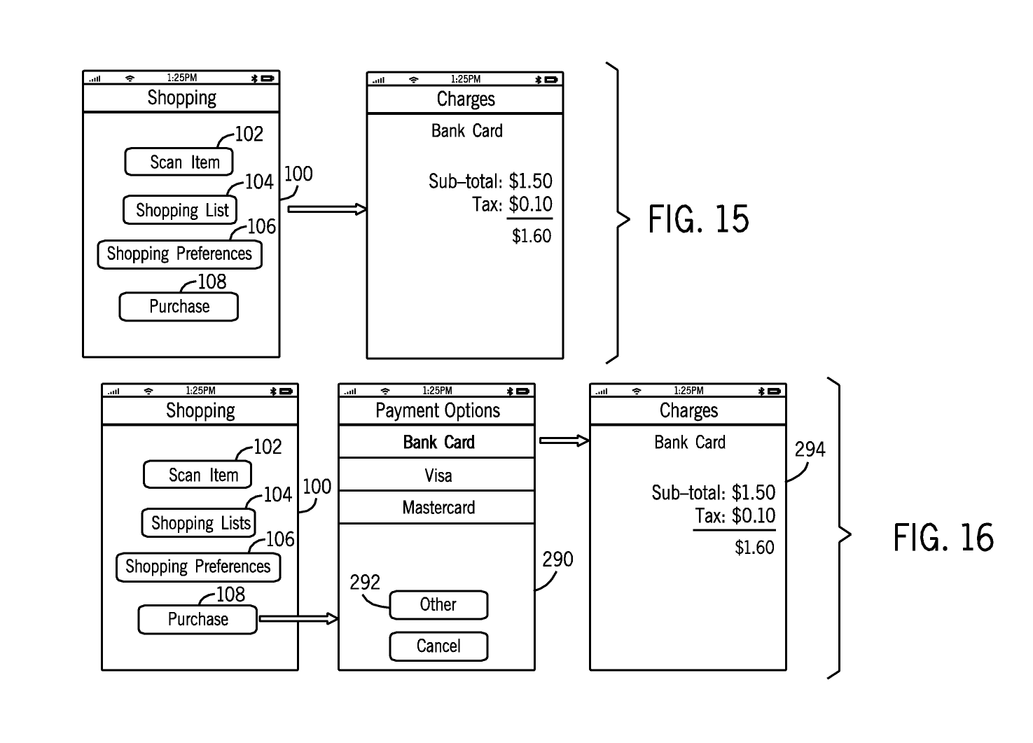

In some embodiments, the device 10 may be configured to operate in a fully automatic mode. That is the device may be configured to automatically use payment methods that have previously been indicated as preferred payment methods for particular contexts. This may be especially useful for purchases that are below a particular price point. For example, when the total price of the items or services being purchased is relatively small, i.e., less than $25 USD. In such cases, no authentication may be required for the use of a credit card or a bank card stored on the device 10. As such, the device 10 may be configured to automatically select a card based on the context of the transaction and complete the purchase based on the preferences without requiring input from the user. FIG. 15 illustrates a charges screen 280 that may be displayed to indicate that the transaction has been completed and that charges were made to a payment option saved on the device 10.

In an alternative embodiment, the device 10 may be configured to provide suggestions of payment options as illustrated in the payment options screen 290 of FIG. 16. The payment options screen 290 is similar to the previously described payment options screens 120 and 200 in that the user may select one of the suggested payment options or may select another payment option using the other button 292. If, however, the user selects one of the suggested payment options, the transaction is completed without any authentication and charges are made to the selected payment options, as shown on the charges screen 294.

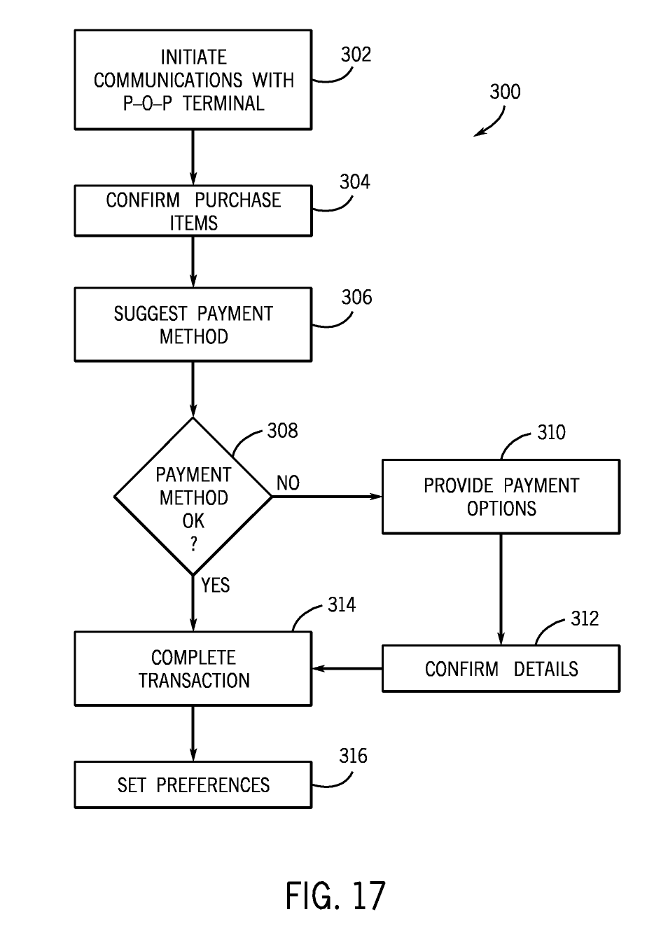

FIG. 17 is a flow chart 300 that provides a general summary of actions that may be taken by the device 10 in the aforementioned transaction 78 with the point-of-purchase terminal 80. NFC communications are initiated between the terminal and the device 10, as shown in block 302. The subject(s) of the transaction may be scanned either by the device 10 or the terminal 80 before, after or during the initiation of the NFC communications are initiated. The user may then have the opportunity to confirm purchase items, as indicated in block 304. Specifically, the purchase items may be listed on the device 10 and the user may add or delete items from the transaction, as discussed above. The device 10 may then provide suggested payment methods, as indicated at block 306. The device 10 may base the decision on context of the transaction. The context may include the identity of the retailer, the brand of the goods, the types of the goods, user preferences for payment options, interest rates for payment options, and incentives related to the payment options, among other things. The suggested payment methods are prioritized by the device to maximize any benefits and to accord with the user's preferences.

The device may then wait for confirmation from a user that a suggested payment option is ok, as indicated at block 308. If the suggested payment option is not ok, payment options are present for the user to select and the details of the transaction are confirmed, as indicated at blocks 310 and 312, respectively, and the transaction is completed as indicated at block 314. Alternatively, if the suggested payment method is acceptable, the transaction may be completed without presenting additional options. The completing of the transaction may include providing authentication information. For example, a user may be required to provide a personal Identification number (PIN), a signature, or a security code, for example. After the transaction has been completed, the information from the transaction may be used to set preference for future transactions. Specifically, the payment option used in the transaction may be set as the preferred payment option for future transactions with the retailer.

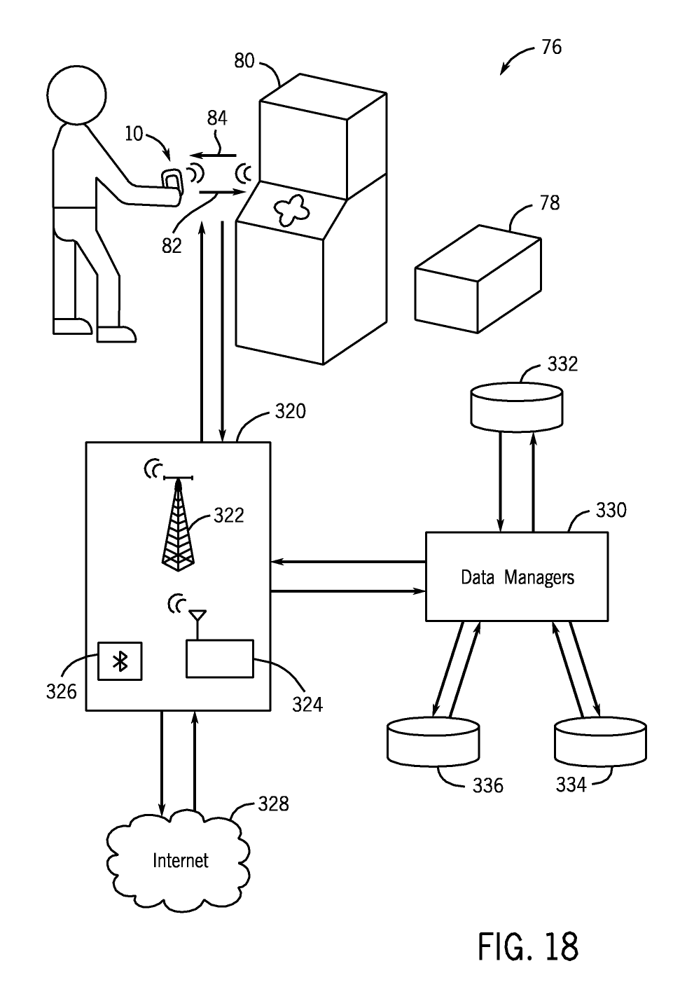

As discussed above, the device 10 may be configured to procure additional information regarding the products involved in the purchase transaction as well as information related to various payment options for the products or for an identified retailer. Specifically, in some embodiments, the device 10 may “scan” products to be purchased. For example, the products may be equipped with NFC devices, such as passive or active RFID tags, which transmit information regarding the products to the NFC interface 50 of the device 10. Alternatively, the device 10 may be configured to read barcodes, QR codes or other codes that contain product identifying information such as a UPC code, model number, serial number, a product name, product description, etc. Thus, the product information, herein referred to as a “product identifier,” may be acquired by the device 10 in any of a variety of suitable methods via barcode scanner, camera, or by entering a product identifier manually.

Where the device 10 is used to scan purchase items, the device 10 may also be used to obtain additional information regarding the products. This may be particularly useful when only a limited amount of information may be provided or available to electronic device 10 from the scan. In order to obtain more extensive information about the product, the electronic device 10 may communicate over a broadband communication system 320, as illustrated in FIG. 18. The broadband communication system 320 may include a cellular communications network 322, local area network 324, or personal area network 326, as described above.

Through the broadband communications system 320, the electronic device 10 may be coupled to the Internet 328 and, thus, the electronic device 10 may be directed to a website related to a particular product, such as a retailer's website or a consumer information website. Moreover, through the broadband communication system 320 the electronic device 10 may communicate with the data manager 330. The data manager 330 may be configured to manage data related to purchase transactions completed by the device, as well as product information and payment options information. The device may send a request packet to the data manager 330 requesting information. Generally, the information request packet may include product identifiers, the geographical location of the electronic device 10, a user ID, personal preference information, etc. In response to the information request packet, the data manager 330 may compile the information sought into one or more data packets to be sent back to the electronic device 10.

To assemble the information for the data packet(s), the data manager 330 may be communicatively coupled to one or more databases. For example, the data manager 330 may be coupled to a manufacturer database 332. The manufacturer database 332 may hold information such as brand name, model number, serial number, UPC code, product types or classifications, product descriptions, suggested retail prices, stores where the product may be available, a media file regarding the product, a web page address for obtaining more information about the product or purchasing the product, among other things. Furthermore, a manufacturer may chose to add information such as coupons, promotions and the like on a fee basis that may be taken into consideration by the device 10 as part of the context of a particular transaction. The coupons and incentives may result in the affect the order in which payment options are presented or suggested to a user.

The data manager 330 may also be coupled to a retailer database 334 which may hold retailer specific product information. As with the manufacturer database, the retailer database 334 may hold information that pertains to the products. Additionally, the retailer database may contain information relating to accepted forms of payment, preferred payment options (for which there may be an incentive for a user to use the preferred payment option), coupons and incentive information, among other things. The information contained in the retailer database 334 may similarly affect the determination by the device 10 of preferred payment methods. In some embodiments, a retailer may pay a fee to the manufacturer of the device 10, for example, to be included in the retailer database 334 or to be able to modify the information in the retailer database 334 to reflect current information.

In some embodiments, both the manufacturer database 332 and the retailer database 334 may contain advertisements that may be sent to the electronic device 10 in response to the information request packet. The advertisements may either be presented directly to the user through sensory media reproducible by the device 10 or indirectly by influencing the determination of suggested payment options. The advertisements may include promotional material related to the purchase of a product and/or marketing partners. For example, the promotional material may provide incentives to a consumer for purchasing the product using a particular payment method. Alternatively, the promotional material may provide incentives, such as a discount, for example, if the purchase of the product is combined with the purchase of another product from the manufacturer or from a manufacturer's partner.

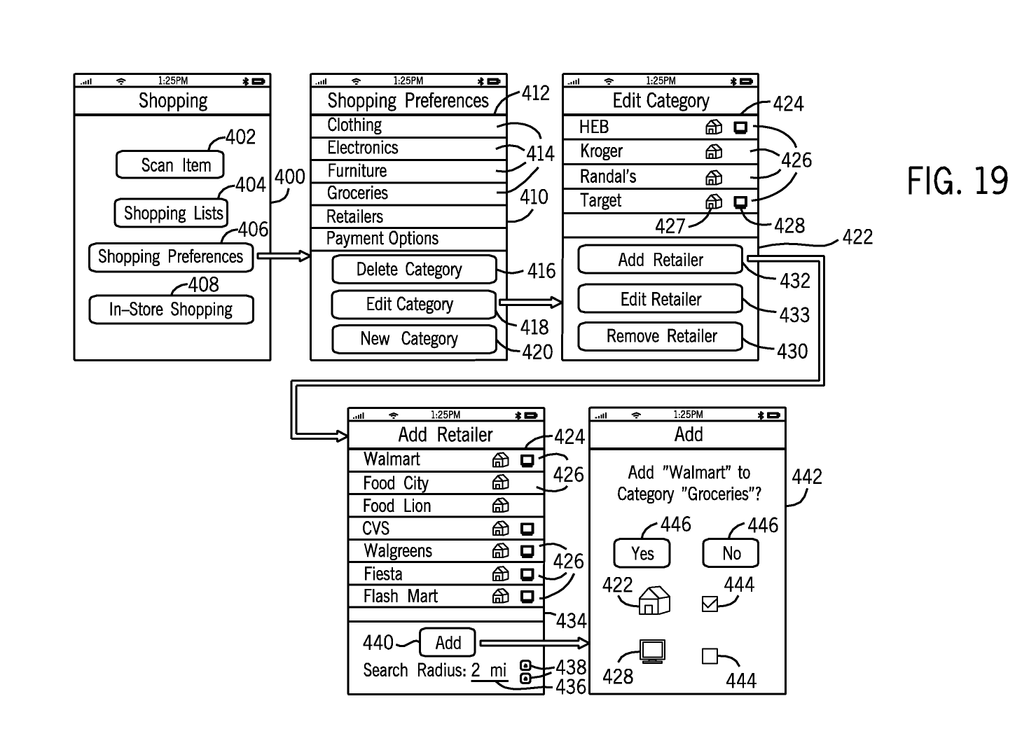

The data manager 330 may also be communicatively coupled to a consumer database 336 which may hold information related to the user of the electronic device 10. For example, the consumer database 336 may include a preference profile of the user of the electronic device 10. The preference profile may include such information as specific retailers that the user prefers and/or specific modes of payment and products that the user prefers. The consumer database 336 may also include information relating to terms such as interest rates for payment options available to a user. Additionally, the database 336 may be populated based on information exchanges between the data manger 330 and the electronic device 10 which may indicate the shopping habits of the user. Additionally, the consumer database 336 may also be populated by personal preferences identified by the user, an embodiment of which is described in relation to FIG. 19. In other embodiments, the information contained in the consumer database 336 may also be included in the memory of the electronic device 10.

As mentioned previously, the content of the communication between the device and the data manager 330 may depend on the information provided by the electronic device 10 in an information request packet. For example, if the user is requesting information regarding incentives payment options for a particular retailer, in response, the data manager 330 may obtain information related to the retailer, the products being purchased. The device may then use the information to determine a payment option to suggest to a user for a particular transaction. Alternatively, the data manager 330 may be configured to use the information to recommend a payment option for the transaction. As such, the data exchanged between the device 10 and the data manager 330 may depend on the way that processing tasks are divided between the electronic device 10 and the data manager 330. It is intended that embodiments are not limited to a particular division of processing tasks between the electronic device 10 and the data manager 330.

FIG. 19 illustrates a method of using the electronic device 10 to specify one or more shopping preferences. As discussed above, in some embodiments, selection of the shopping icon 34 (FIG. 1) may advance the user to a shopping screen 100, which may serve as a gateway to the shopping features of the electronic device 10. The shopping screen 100 may include several graphical elements such as buttons 102, 104, 106 and 108, which allow the user to access the shopping feature indicated. As will be explained further below, embodiments allow the user to set preferences with respect to the use of various payment methods. Further, the device 10 may be configured to autonomously provide recommended payment methods for particular transactions based upon the user preferences, as mentioned above.

Upon selection of the shopping preferences button 106, the user may be advanced to a shopping preferences screen 410. To provide the user a quick way to specify one or more preferences when prompted, the electronic device 10 may allow the user to create and save one or more lists related to preferred retailers ahead of time. The shopping preferences screen 410 may include a category list 414 that includes several preference categories 414 related to purchase transactions. For example, the preference categories may include retail products, such as groceries, clothing, electronics, home appliances, furniture, office supplies, automobiles, sporting goods, etc. as well as a payment options category. In some embodiments, one or more of the categories 414 may be preloaded by a manufacturer of the electronic device 10, and one or more categories may be custom created by the user. The listing of categories may be customized by the user by using the delete category button 416, the edit category button 418 and the new category button 420. Specifically, categories may be deleted by selecting an individual category within the retailer category list 412 and touching the delete category button 416. New categories may be created by selecting the new category button 420. Categories may be edited and customized by selecting the retailer category 414 in the retailer category list 412 and pressing the “edit category” button 418.

If, for example, a user selects a particular category, such as groceries and then selects the edit category button 418, the user is brought to an edit category screen 422. As shown in the edit category screen 422, the categories 414 may include a retailer list 424 which includes several retailer listings 426 that fit within that particular category. In addition to the name of the retailer, each retailer listing 426 may also includes one or more icons. For example, a retailer listing 426 may include a building icon 427 that indicates that the retailer listing pertains to a physical store location. The retailer listing 426 may also include an on-line icon 428 that indicates that the retailer listing 426 pertains to on-line shopping. The presence of a building icon 427 or an on-line icon 428 may indicate the preference of the user regarding whether they wish to purchase items from that particular retailer on-line or at the store. The retailer listings 426 included within a retailer category 412 may be preloaded by the manufacturer of the electronic device 10, possibly in exchange for a fee from the retailers, and may also be edited by the user to include only those retailers that the user frequents. In other embodiments, an edit category screen may list user selected payment methods for a particular category listed in the shopping preferences screen 410.

The user may remove a retailer by selecting a retailer listing 426 in the retailer list 424 and selecting the remove retailer button 430. Additionally, a user may add or edit a retailer's information using add retailer button 432 or edit retailer button 433. Upon selection of the add retailer button 432, a user may advance to an add retailer screen 434. This may also cause the electronic device 10 to send an information request to the data manger 330, requesting a list of retailers from the retailer database 334.

The add retailer screen 434 may include a retailer list 424, which may include all the retailers contained within the retailer database 334 or may be narrowed to provide a more focused set of relevant retailers. For example, the retailer list 424 may be narrowed to include only those stores within a specified radius, geographic region, zip code, etc. For example, the radius may be relative to the geographical location of the electronic device 10 or a geographical location specified by the user.

In some embodiments, the device 10 may be configured to autonomously determine the device's location using the positioning system 70, cellular communication via the network device 64, or even via NFC communication with the point-of-purchase terminal 80 or an available Wi-Fi network. Upon determination of the location of the device 10, the device 10 may search for retailer within a user set radius. As such, the add retailer screen 434 may include a search radius indicator 436 by which the user may specify the search radius used to acquire the retailer list 424. The add retailer screen 434 may also include buttons 438 for increasing or decreasing the search radius.

As in the edit category screen 418, the add retailer screen 434 may also include icons, such as the building icon 427 and the on-line icon 428. However, in the add retailer screen 434, the building icon 427 and the on-line icon 428 may indicate whether the retailer exists as a physical store and/or whether it has an on-line shopping presence. To add one of the retailers from the retailer list 424 to the retailer category 414, the user may select the retailer in the list and press the add button 440, which advances the user to the add screen 442. The add screen 442 may include a message requesting confirmation that the user would like to add the selected retailer to the retailer list 424. The add screen 442 may also include check boxes 444 which are adjacent to and correspond with the building icon 427 and the on-line icon 428. The user may select or de-select the check boxes 444 to indicate whether the user wishes to add the retailer as a “brick-n-mortar” retailer and/or an on-line retailer. Selection of one of the confirmation buttons 446 may add the retailer selected to the retailer category 424 and return the user back to the edit category screen 422 or the add retailer screen 434.

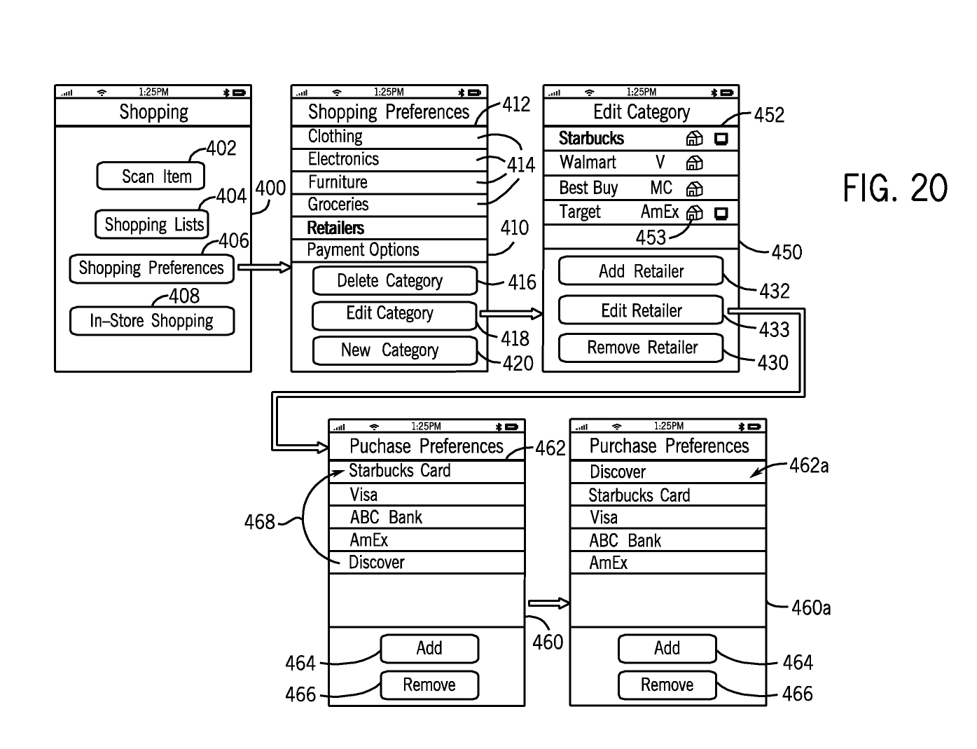

Referring now to FIG. 20, a user may set preferences related to specific retailers by selecting the retailers button and the edit category button on the shopping preferences screen 410. The user may then be brought to an edit category screen 450 that contains a listing 452 of retailers that may have been previously loaded by the user. Alternatively, the retailers may be partnered with the manufacturer of the device 10 and may pay a fee to be preloaded into the device 10. In addition to listing retailers, the listing 452 may include an indication as to the current priority payment option for the retailer. For example, the listing 452 may include icons or trademarks or other indicators 453, such as a “V” for Visa, “MC” for Mastercard, etc., as shown for the priority payment method for each retailer. As above, the user may add retailers, edit retailers or remove retailers using the buttons 430, 432 and 433. If the user selects one of the listed retailers and then selects the edit retailer button 433, the device may display a purchase preferences screen 460. The purchase preferences screen 460 may include a prioritized listing 462 of payment methods for the selected retailer. The prioritized listing 462 may be based on prior transactions with the selected retailer or previously set user preferences. In an alternative embodiment, a retailer and/or financial institution for a payment option may pay a fee to the manufacturer of the device 10 to have a particular payment option default to the first priority payment option, until a user indicates otherwise. Once a user sets a priority for use of a particular card with a particular retailer, that preference setting may supersede default settings and other general preference settings and/or preferences suggested by the device based on other transactions or settings.

The user may add or remove payment options from the listing 462 using the add button 464 and the remove button 466. Additionally, a user may reorder the priority listing 462 by dragging and dropping the listed payment options. For example, if the user wanted to use a Discover card as the first priority payment option for the selected retailer, the user may simply select the listing for the Discover card and drag the listing to the top of the priority listing 462, as indicated by arrow 468. The resulting listing 462a is shown in the modified purchase preference screen 460a. As such, the Discover card may be the first priority payment method for that particular retailer, regardless of other preferences and/or default settings.

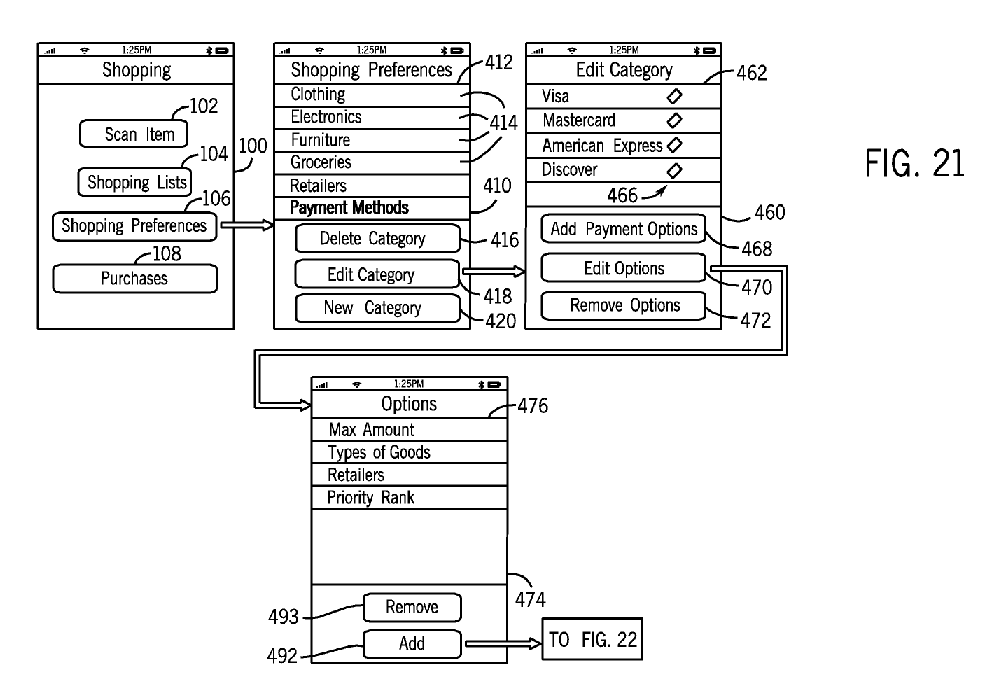

Referring again to the shopping preferences screen 410, a user may also set preferences for the payment methods by selecting payment methods and the edit category button 418, as shown in FIG. 21. The user is then directed to an edit category screen 460 which may allow a user to add, delete or edit possible payment methods. As illustrated, the edit category screen 460 may provide a listing of various payment options 462 that a user may have already loaded into the device 10. Specifically, for example, the payment options may include Visa, Mastercard (MC), American Express (AmEx), Discover, etc. Each of the various payment options may include an icon 466 that may represent a credit card, for example. Alternatively, a miniature trademarked symbol for some payment methods may be used, as they could possibly provide for quicker recognition of the particular payment methods.

A user may add preferences for the payment options using the add payment option button 468, edit payment options using the edit options button 470, or delete payment options using the remove payment options button 472. Upon selection of the edit options button 470, a user may be brought to an options screen 474. The options screen 474 may include a listing 476 of possible options that a user may set with respect to the selected payment method. For example, possible options may include a maximum amount, types of goods, retailers where the payment option may be used, and general priority ranking, among others.

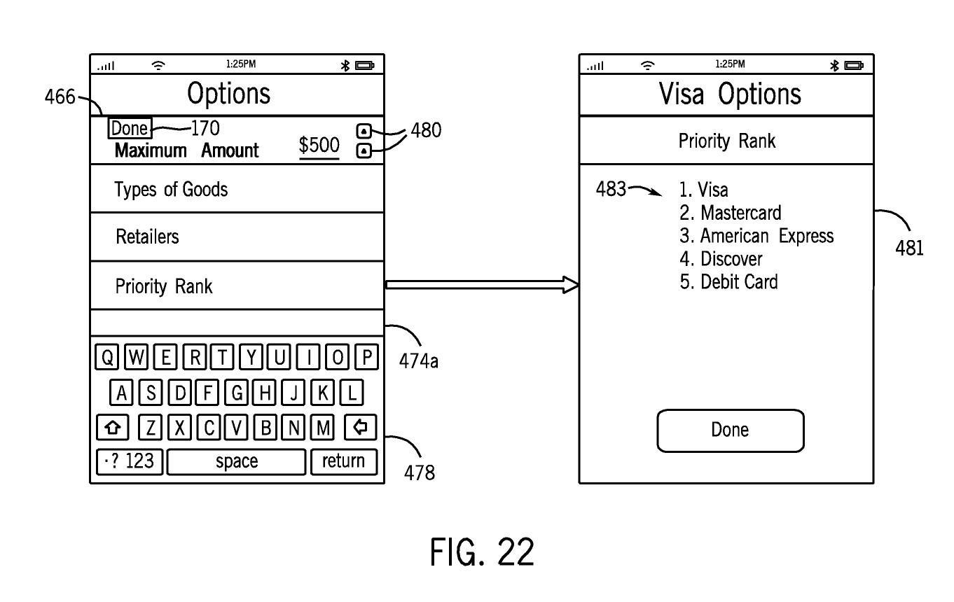

The maximum amount option may refer to a maximum single purchase sum for which the payment method may be used. A user may choose to have the maximum amount coincide with the card's credit limit or, alternatively, for example set the maximum amount to a value lower than the limit to aid in budgeting and to prevent use of the card for relatively large purchases. Upon selection the maximum payment amount option, by touching the maximum amount, for example, a user may adjust the amount by typing in an amount, such as $500, using a keyboard 478 that appears upon selection of the maximum amount, as shown in FIG. 22. Alternatively, the user may use up and down buttons 480 which may be used to increase or decrease the maximum amount in a predetermined amount step-wise manner. For example, the up and down buttons 480 may increase and decrease the maximum amount by $10 or $50 per actuation. When a user has set the amount, selection of a return button on the keyboard may return a user back to the options screen 474.

Alternatively, the user may simply select one of the other listed options to set preferences with respect to the other options. For example, the user may select the priority rank options to be brought to a priority rank options screen 481. The priority options screen 481 may include a listing 483 of all of the various payment options that have been loaded into the device 10. The user may set a general priority rank for the various payment options by placing a first preferred payment option at the top of the listing 483 and other payment options in order of preference following. Thus, a general priority status for the payment options may be established by the user. The user may set the priority status of one card above another due to a favorable interest rate, or a particular incentive program for the payment method, for example.

The listing 476 may also include a type of goods category which may allow a user to select particular types of goods or services which the selected payment method may be used to purchase. For example, a particular credit card may have retail partners that agree to provide additional benefits when the card is used for the purchase of a particular good. For example, a credit card may provide incentives such as an annual cash back reward based on a percentage of total purchases made during the year on select goods. The percentage of the cash back may vary based on the type of good, i.e., 3% cash back on gas and 1% on all other purchases. Additionally, or alternatively, a credit card may partner with a retailer to provide rebates or discount incentives when the credit card is used to purchase certain types of goods from the retailer. In such a case, a user may indicate that the card may be used for purchases of those types of goods in order to help maximize the benefit of using the card.

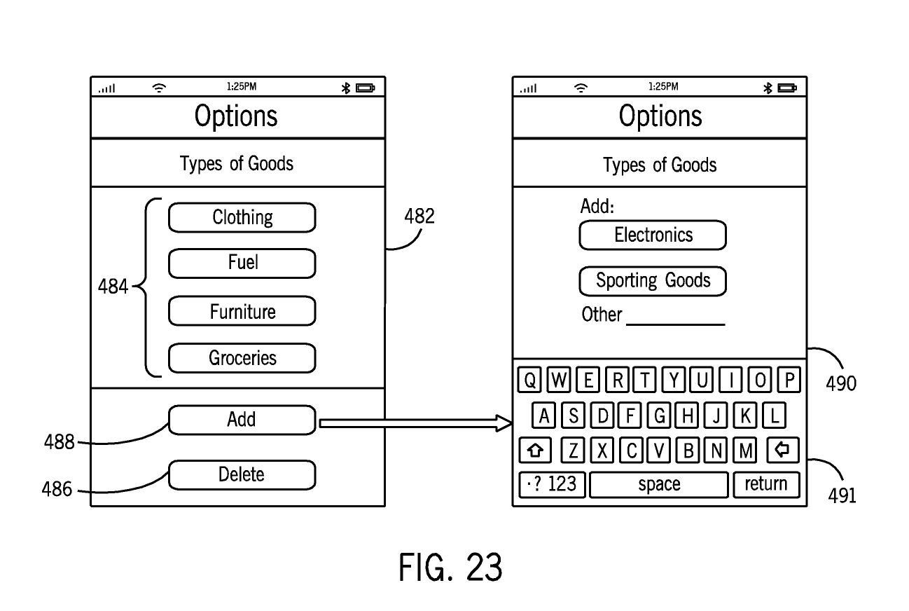

Upon selection of the types of goods, a types of goods screen 482, as shown in FIG. 23, may be displayed which may list goods and services 484 which the user has indicated to be purchased using the card. Goods and services 484 may be removed from the listing using the delete button 486, in accordance with aforementioned techniques. Additionally, goods and service may be added to the listing using the add button 488. Upon selection of the add button 488, a user may be presented with a screen 490 that may list additional categories of goods and service which may be selected. The user may add types of goods that have been provided or alternatively, the user may add other types of goods using the keyboard 491. If the user inserts other types of goods, the device may be configured to align the types of goods with known categories and/or seek to identify goods that fit into the type of good category by searching descriptions of scanned items.

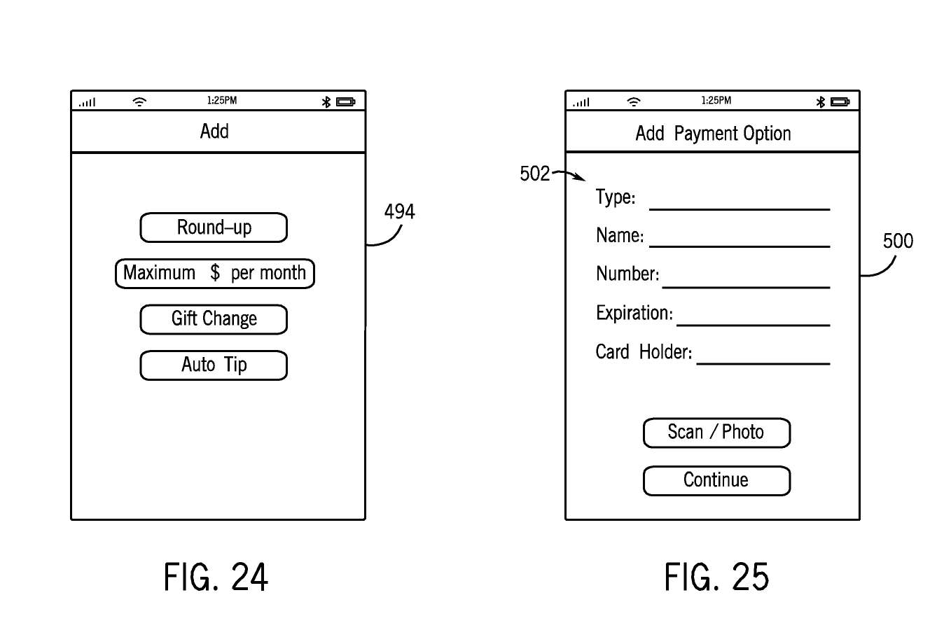

Referring again to FIG. 21, additional options may be added by pressing the add button 492 and options may be removed from the list 476 by selection of the remove button 493. Upon selection of the add button 490, a user may be brought to an add screen 494 as illustrated in FIG. 24. The add screen 494 may include a selection of additional options for a user. For example, the user may select a round up option, a maximum (max) money per month option, a gift change option and an auto tip option among others.

The round up option may allow a user to round purchases up a set amount and automatically move the rounded up portion of the transaction into a savings account. Similarly, the gift change option may allow a user to round up transactions and gift the rounded up portion of the transaction to a charity. In each of the round up and gift change options, the user may set the round up threshold. For example, the user may set the round up threshold to be one dollar, in which each transaction will be rounded up to the nearest dollar. In an alternative embodiment, the user may set a fixed amount to be deposited into the savings account or given to charity each time the user uses the payment option. For example, the user may set the round up or gift change options to donate one dollar each time a particular payment method is used. If a user selects either the round up or gift change options, the user may be brought to a screen that allows for an indication of where the change of the transaction should go. Specifically, for example in the round up option, a user may select a particular savings account or money market account where the change can be deposited. Alternatively, in the gift change option, user may be able to indicate a particular bank account related to a charity of choice, for example.

The maximum money per month option may allow a user to set maximum amount of money for which a particular payment method may be used in a month. Stated differently, the maximum money per month may set a monthly spending limit on selected payment methods or spent from a particular payment option on a monthly basis. The auto tip option may allow a user to set the device 10 to automatically tip on certain types of purchases, on transactions with a particular retailer or type of service entity when using a certain payment method. Additionally, if the user selects the max maximum money per month option or the auto tip option a user may be brought to screens allowing the setting of a particular amount such as a dollar amount in the case of the max money per month option, or a set percentage for the auto tip option. The user may set the amount as a fixed percentage of charges billed at a restaurant, for example.

Referring again to FIG. 21, as mentioned above, the user may also add payment options using the add payment options button 468. Upon selection of the add payment options button 468, an add payment option screen 500 may be displayed, as illustrated in FIG. 25. The add payment option screen 500 may allow a user to input information related to payment options. As discussed in detail below, there are several ways in which the information may be entered. For example, information related to the payment options may be added manually by typing information, wirelessly via NFC, Wi-Fi, Infrared, etc., scanning cards or taking pictures or card, among others. Some of these methods will be described below. For additional details, reference may be made to the patent application filed Sep. 30, 2008, by Gloria Lin, Amir Mikhak, Taido Nakajima, Sean Mayo and Michael Rosenblatt, entitled “Peer-to-Peer Financial Transactions,” patent application Ser. No. 12/286,494, which is incorporated herein by reference.

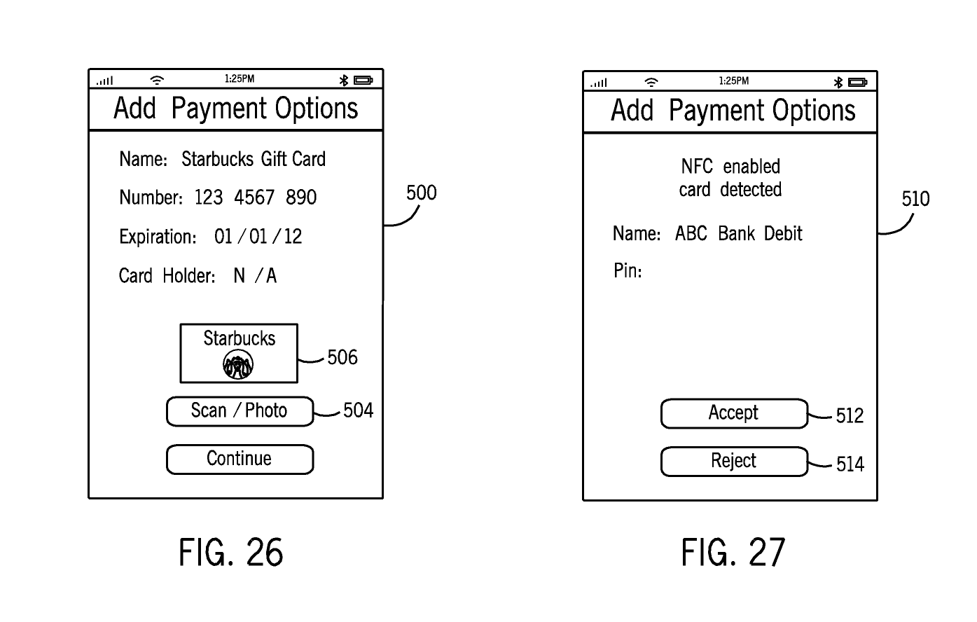

The add payment option screen 500 may include a number of fields 502 that allow a user to manually enter information related to the card. For example, the fields may include a field for the type of card (i.e., credit, debit, cash, etc.), a name for the card (i.e., ABC Bank card), a number and an expiration date and a cardholder name so that the card may be used by the device 10 in making purchases. FIG. 26 illustrates the add payment options screen 500 after information has been entered. As may be noted, the card holder field is indicated as being not-applicable because it may be a cash card or a gift card that may be used as cash and no user name or cardholder name need be associated with the card.

A user may select a scan/photo button 504 to take a picture or scan the card. The image of the card may be used as an icon in listing of the particular payment option, as mentioned above. Additionally, the image 506 which has been taken by the device 10 may be displayed below the payment option listing in the add payment options screen 500, as illustrated in FIG. 26. If the user desires a different image, the user may again press the scan/photo button 504 and take another picture to replace the previous picture or alternatively may download an image and associate the downloaded image with the payment option. As mentioned above, in some embodiments the image of the card may be used to fill in the fields of the add payment option screen 500. Specifically, software may be loaded onto the device to allow it to recognize and interpret the information on a card that has been scanned or that the device 10 has photographed. As the device 10 may not always be able to accurately interpret the information, a user may be able to edit the information manually after the fields 502 have been automatically filled by the device 10.

In some embodiments, the device 10 may be configured to detect when NFC enabled payment options, such as NFC enabled bank cards, for example, are in proximity to the device 10. In such instances, the device 10 may be configured to obtain the information from the NFC enabled card or payment option and add the information to the listing of payment options that are included on the device. This may be performed when selecting to add a payment option in accordance with the present techniques. Specifically, after a user has indicated a desire to add a payment option by selecting the add payment options button 468, and the add payment options screen 500 appears, the device 10 may scan for NFC devices. If no NFC devices are found, the device 10 may operate normally as discussed above.

However, when the device 10 detects a NFC enabled payment option while the add payment option screen 500 is displayed, screen 510 may be prompted, as illustrated in FIG. 27. Screen 510 may indicate to a user that an NFC enabled payment option has been detected. Additionally, screen 510 may list a description of the detected NFC enabled payment option, for example, ABC bank debit. The user then may be required to enter a personal identification number, a password, a security number, or the like in order to authenticate the user and add the payment option to the device 10. Before or after entering the authentication information, the user may choose to accept or reject the detected payment option using buttons 512 and 514, respectively. Upon selection of the decline button the user may be returned to the add payment options screen 500.

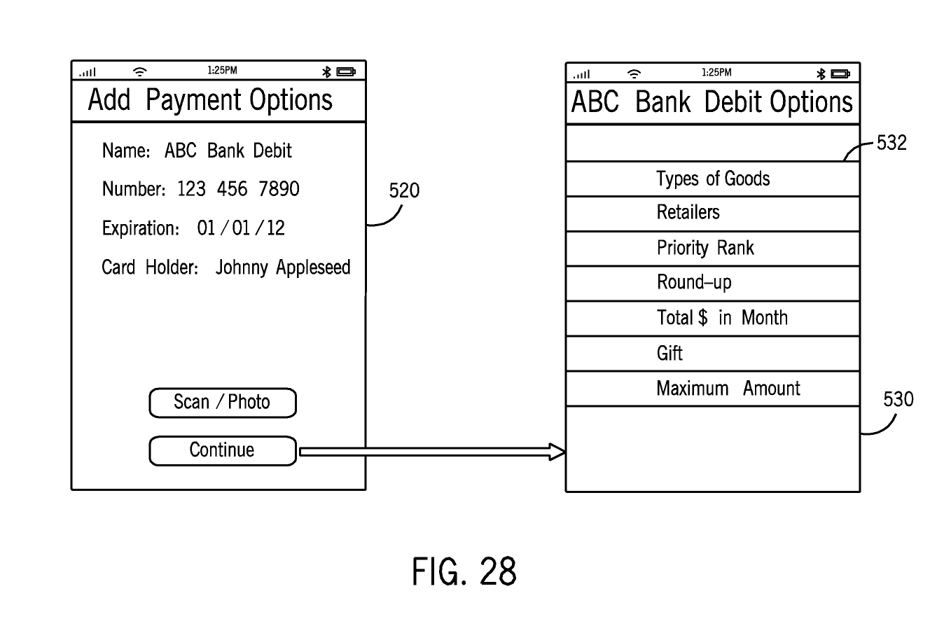

Alternatively, upon selecting the accept button 512, the user may be brought to a completed add payment options screen 520 which may list the details of the newly added payment option, as shown in FIG. 28. Again, the user may select to scan or take a photo of the card which may prove useful to more quickly identify the card during transactions. Once the new payment option has been added, a user may select to continue by selecting the continue button 522 which may direct the user to an options screen 530 for the newly added payment option. Specifically, as illustrated in FIG. 28, options screen 240 which may contain a listing 532 of various options or preferences related to the use of the newly added payment option. The listing 532 may include options such as types of goods for which the payment option may be used, retailers at which the card may be used, priority ranking, round up option, a total amount to spend in a month option, a gift option and a max amount option in addition to others. As discussed above, the details of these options may be further fleshed out in accordance with the aforementioned techniques. Thus, the user may be able to specify usage patterns for the particular payment options that are added into the device 10.

Once user preferences and payment options have been entered into the device 10, the device 10 may conduct purchase transactions, such as transaction 76 (FIG. 4) with retailers using the various payment options. Additionally, as discussed above, the device 10 may be configured to provide smart menu options when interacting with retailers for which preferences have not been set. For example, the device 10 may automatically present options to a user based on the context of the transaction that accord with user preferences and/or that may take advantage of incentives associated with the use of particular payment methods. Additionally, the device 10 may be configured to procure information related to payment options in order to determine a suggested priority of payment options. In making the suggested priority, the device may consider, among other things, interest rate, retailer, type of goods, payment options incentives, such as cash back, etc. Moreover, the device 10 may be configured to autonomously conduct low cost transactions without the need for user intervention.

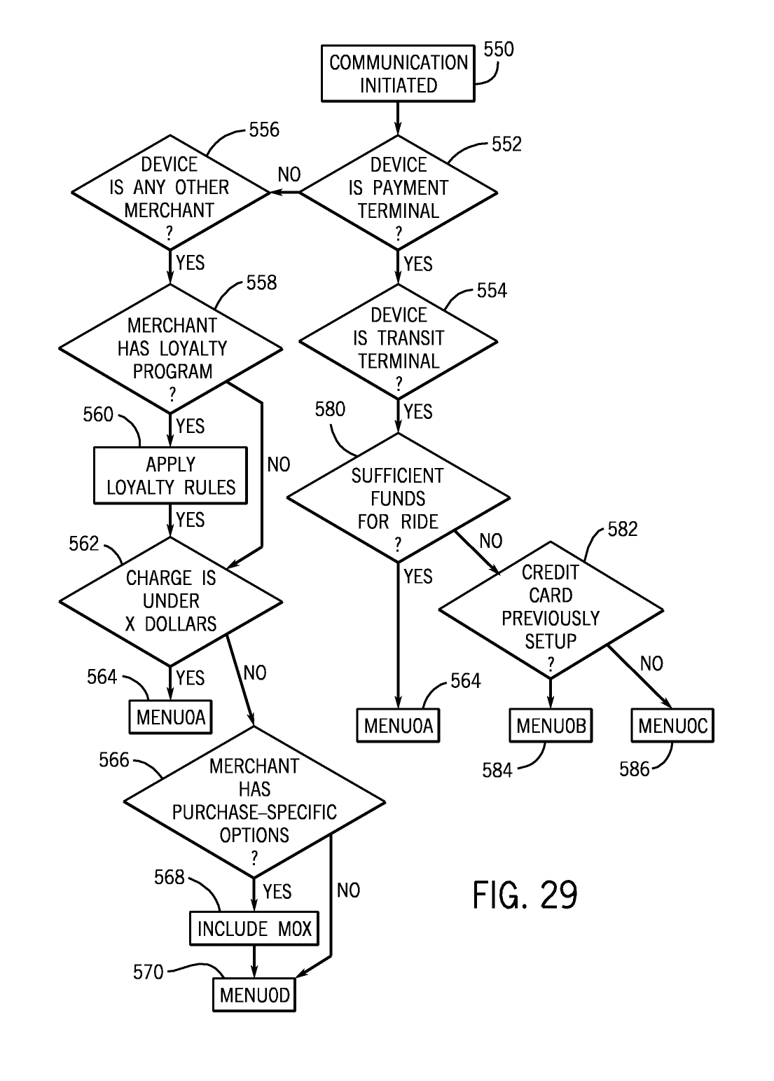

In any single transaction, there may be a variety of decisions made by the device 10 in order to complete a transaction and provide the smart menus to the user. FIG. 29 is a flow chart illustrating a transaction in accordance with various embodiments. As illustrated, communication between the device 10 and a terminal may be initiated, at block 550. During the initiation of the communications basic information may be exchanged including the identity of the terminal, as discussed above. The device 10 may then determine if the device with which it is communicating is a payment terminal, at decision block 552. If it is a payment terminal, the device 10 may be configured to determine if the payment terminal is a transit terminal, at block 554.

If the payment terminal is not a transit terminal, the device 10 may determine if it is associated with any other merchant, at block 556, and if the merchant has a loyalty program, at block 558. If it is determined that the merchant has a loyalty program, the device 10 may be configured to apply loyalty rules to maximize benefits that may be incurred through making purchases from that merchant. For example, the merchant may be partnered with a particular credit card to provide incentives to a user, as discussed above. Alternatively, or additionally, the user may be a member of a loyalty rewards program that requires a user to present membership identification, such as a rewards card, etc. in order to receive a discounted price on purchases, for example. In one embodiment, if the merchant has a loyalty program but the device 10 is not aware of the program (i.e. it has not be configured to implement loyalty rules for the particular merchant), the transaction terminal may indicate to the device 10 that a loyalty program is available and a user may be provided with the option to participate. If the user selects to participate in the loyalty program, then the device 10 may be configured to store the loyalty program and the associated details into the user's preferences for that particular merchant so that loyalty rules will be applied in future transactions with the merchant.

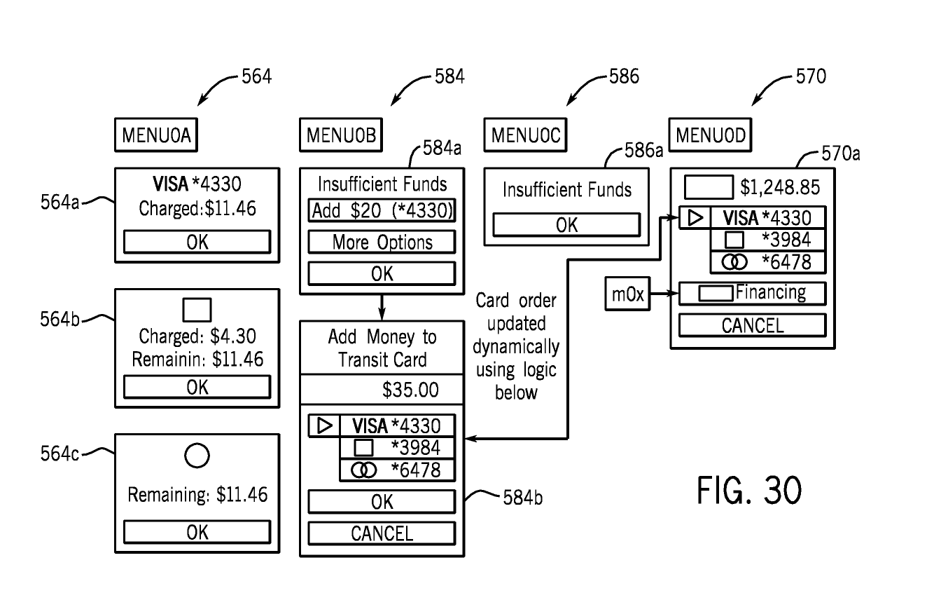

If there is no loyalty program or after applying loyalty rules, the device may then determine if the transaction total is less than a threshold amount, at block 564. The threshold amount may be set in accordance with the aforementioned techniques. If the transaction is less than the threshold amount, a user may be directed to a menu, at block 564, such as menu0a shown in FIG. 30. As shown in FIG. 30, menu0a may provide a user with a different payment option depending on the context of the transaction and in accordance with the user defined preferences. For example, the menu0a may provide a user with the option to pay with a visa card, as shown in menu 564a, a Bay Area Rapid Transit (BART) card 564b or other payment option 564c based on the context of the transaction. The user may select the ok button in order to complete the transaction using the payment option. In some other embodiments, the user may be able to decline use of the suggested payment option and select another mode of payment for completing the transaction, as discussed above.

Alternatively, if the transaction total exceeds the threshold, the device 10 may be configured to determine if the merchant provides alternative payment methods, at block 566, such as financing, for example. If so, the device 10 may include a m0x option, at block 568, and a user may be directed to a menu0d, at block 570. The menu0d may include a listing of payment options available to a user as shown in FIG. 30. The listing may be prioritized in accordance with user preferences as discussed above. The user may select one of the listed options or cancel the transaction from the menu0d. In an alternative embodiment (not shown) if the merchant does not provide alternative payment options, the menu0d would not include the financing option m0x, but the user may still select a listed payment option from the menu0d to complete the transaction.

Returning again to block 554, where the device 10 determines if the transaction terminal is a transit terminal. If it is a transit terminal, the device 10 may determine if a preferred payment options for transit has sufficient funds, at block 580. If the preferred payment option does have sufficient funds, the user is brought to menu0a, at block 564. As discussed above, the menu0a may provide the user with a specific payment option based on the context of the transaction. In the case of conducting a transaction with a transit terminal, the device 10 may provide the user with the option to pay with a transit card, such as a BART card as shown in 564b (FIG. 30), for example.

If, however, the device 10 determines that there are insufficient funds, at block 580, the device may then determine if a card has previously been set up for the transit transaction. If so, then a user may be brought to a menu0b, at block 584. The menu0b (FIG. 30) may direct the user to an insufficient funds screen 584a from which the user may select to add a preset amount, such as $20.00 for example to the transit payment options. Alternatively, the user may select more options to add different amounts to the transit payment option. Specifically, if the user selects a more options button, the user may be brought to a add money screen 584b that allows a user to enter any amount from a listing of other payment options, as shown in FIG. 30.

Alternatively, if no payment option, such as a transit card or credit card, for example, has previously been set up, a user may be directed to a menu0c, at block 586. The menu0c, as shown in FIG. 30, may simply indicate via an insufficient funds screen 586a that insufficient funds are available for the transaction. In some embodiments, after the selection of an ok button on the insufficient funds screen 586a, a user may be directed to a screen (not shown) that allows a user to select a payment option in accordance with the aforementioned embodiments. The user may then set the selected payment option as a preferred payment option.

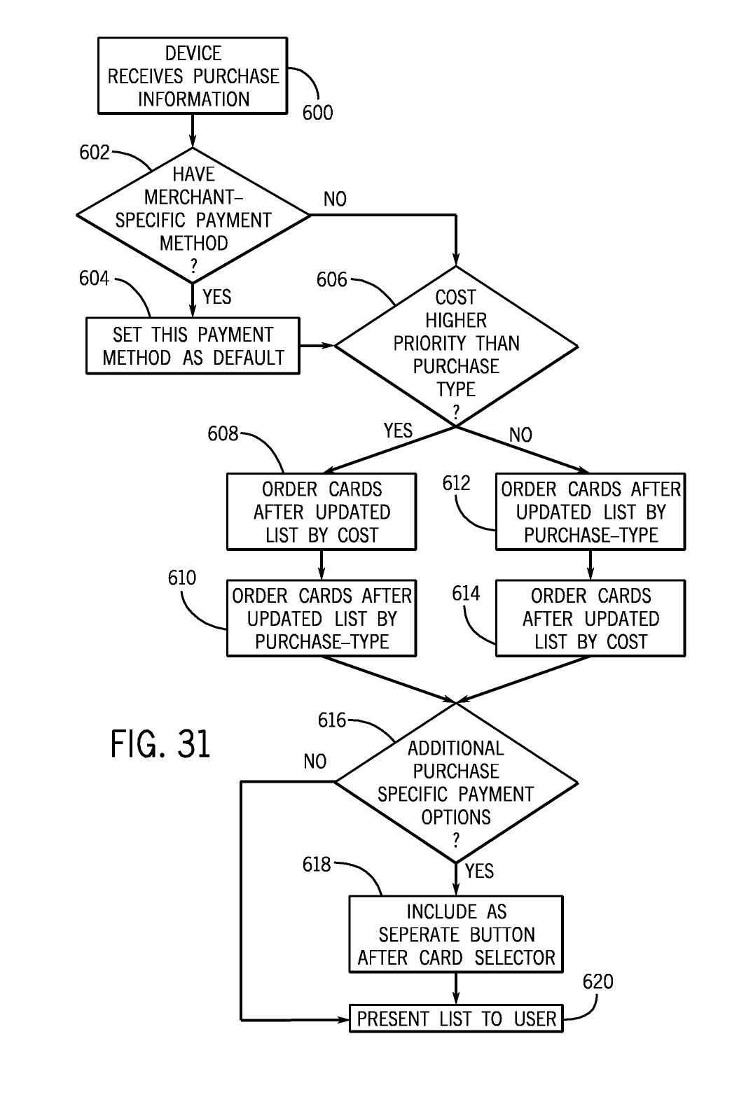

Referring now to FIG. 31, a flow chart illustrating logic flow for determining a payment option priority for a transaction is shown in accordance with some embodiments. The device 10 may be configured to receive purchase information, as indicated at block 600. This information may be acquired directly by scanning an item to be purchased using the device 10 or by establishing communication with a transaction terminal, as discussed above. The device 10 may then determine if there is a merchant specific payment method, as indicated at block 602. The merchant specific payment method may be a merchant gift/cash card, for example, or a payment option that provides benefits to a user for using the payment options for purchases from the merchant. The device 10 may be configured to determine if a merchant specific payment method is available for use for the transaction based on information regarding payment options stored on the device 10. Alternatively, a merchant transaction terminal may be configured to indicate payment methods that may incur benefits to a user when used for purchases from the merchant.

If the device 10 determines that there is a merchant specific payment method, a user may be prompted to set the payment method as default for transactions with the merchant, as indicated at block 604. After the user has indicated weather to set a default setting for a payment method, or if there is no merchant specific payment method available, the device 10 prioritizes payment methods in accordance with a user's preferences. Specifically, the device 10 may be configured to determine if the cost of the transaction or a purchase type has a higher priority in determining the payment method, as indicated at block 606. The priority may be set in accordance with information provided from the user to the device 10.

If the device 10 determines that the cost has a higher priority than the type of purchase, the device 10 may be configured to order a listing of payment options based on cost and then order the cards by purchase type, as indicated in blocks 608 and 610. Specifically, for example, a user may have payment options available that are limited in the amount for which they may be used for a transaction. For example, a user may set a limit on single transactions for a debit card. Alternatively, a particular credit card may be preferred for relatively large purchases so that a user may accrue benefits, such as frequent flier miles, for example. Additionally, certain benefits may inure to a user for using a particular payment method for certain purchases. For example, a user may earn 3% cash back for buying gasoline using a particular payment method. As such, the device 10 may be configured to perform a primary prioritization of payment options based on the cost of the transaction, as indicated at block 608, and, subsequently, a secondary prioritization based on the purchase type, as indicated in block 610. Alternatively, if purchase type takes priority over the cost, the device 10 may perform a first prioritization based on purchase type, as indicated at block 612, and then a secondary prioritization based on cost, as indicated at block 614.

After the payment option shave been prioritized, the device 10 may determine if there are any purchase specific payment options, as indicated at block 616. If there are purchase specific payment options, such as a particular brand being purchased, for example, the device 10 may be configured to include a separate button for the user to select, as indicated at block 618. Specifically, for example, if the user has a credit card affiliated with a particular brand, the device 10 may provide a button specifically for purchases of that brand. After the prioritization of the payment methods, the list of payment methods may be presented to the user, as indicated at block 620.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A handheld electronic device, comprising:
an input device configured to receive a product identifier associated with a product;
a wireless networking interface configured to transmit a request for product information associated with the product to a data manager via a network and receive product information associated with the product from the data manager via the network;
a processing device configured acquire the product identifier from the input device, send the request to the wireless networking interface for transmission to the data manager, and display the product information received from the data manager.

27. The handheld electronic device of claim 26, comprising a positioning device configured to provide a location of the electronic device; and
wherein the request for product information includes an indication of the location of the handheld electronic device.

28. The handheld electronic device of claim 27, wherein product information comprises a list of one or more retailers selling the product.

29. The handheld electronic device of claim 28, wherein the list of one or more retailers selling the product can be modified by a user-specified search radius in which to search for retailers.

30. The handheld device of claim 28, wherein the processing device is configured to determine a distance between the one or more retailers and the location of the handheld device.

31. The handheld device of claim 28, wherein the processing device is configured to provide turn-by-turn directions from the location of the handheld device to the one or more retailer.

32. The handheld electronic device of claim 26, wherein the processing device is configured to allow a user of the handheld electronic device to submit a rating for the product to the data manager via the wireless networking interface.

33. The handheld electronic device of claim 26, wherein the handheld electronic device is configured to receive an advertisement from the data manager, and wherein the data manager sends the advertisement based, at least in part, on the product identifier.

34. The handheld electronic device of claim 26, wherein the input device comprises a near field communications device.

35. The handheld electronic device of claim 26, wherein the handheld electronic device is configured to allow a user to purchase the product on-line.

36. A non-transitory computer-readable medium comprising:
a medium configured to store computer-readable instructions thereon; and
the computer-readable instructions that, when executed by a handheld electronic device, cause the processing device to perform a method, comprising:
acquiring a product identifier from a product located near a handheld electronic device;
transmitting a request related to the product identifier from the handheld electronic device to a data manager via a wireless network, the data manager communicatively coupled to a database of product information;
receiving product information associated with the request related to the product identifier from the data manager via the wireless network; and
displaying the product information on the hand-held electronic device as a list of user touch selectable icons related to select retailers selling the product and pricing of the product by each of the retailers.

37. The non-transitory computer-readable medium of claim 36, the handheld electronic device further comprising a positioning device configured to provide a location of the electronic device, wherein the request for product information includes an indication of the location of the handheld electronic device, and wherein product information comprises a list of one or more retailers selling the product.

38. The non-transitory computer-readable medium of claim 37, wherein the list of one or more retailers selling the product can be modified by a user-specified search radius in which to search for retailers.

39. The non-transitory computer-readable medium of claim 37, the instructions further causing the processing device to perform the steps of determining a distance between the one or more retailers and the location of the handheld device.

40. The non-transitory computer-readable medium of claim 37, the instructions further causing the processing device to perform the steps of providing turn-by-turn directions from the location of the handheld device to the one or more retailer.

41. The non-transitory computer-readable medium of claim 37, the instructions further causing the processing device to perform the steps of transmitting a user-supplied rating for the product to the data manager via the wireless networking interface.

42. The non-transitory computer-readable medium of claim 37, the instructions further causing the processing device to perform the steps of receiving an advertisement from the data manager based, at least in part, on the product identifier.

43. A system for providing targeted advertising to an electronic device, comprising:
a data manager configured to receive an information request from a handheld electronic device via a wireless network, the information request regarding a product identified by the handheld electronic device; and
one or more databases communicatively coupled to the data manager, the one or more databases comprising information related to the product and advertisements related to the product;
wherein the data manager is configured to transmit the advertisement to the electronic device via the wireless network in response to the information request; and
wherein an operator of the data manager and the one or more databases populates the one or more databases with information and advertisements provided by one or more retailers and/or one or more manufacturers in exchange for a fee paid by the one or more retailers and/or one or more manufacturers.

44. The system of claim 43, wherein the electronic device comprises a web browser and wherein transmitting the advertisement to the electronic device comprises transmitting a web page address to the electronic device.

45. The system of claim 43, wherein the electronic device comprises an audio player and a video player and wherein transmitting the advertisement to the electronic device comprises transmitting a video file, or an audio file, or both.
